(19) United States
(12) Patent Application Publication
(10) Pub. No.: US 2018/0048831 A1
(43) Pub. Date: Feb. 15, 2018

(54) GENERATION OF COMBINED VIDEOS

(71) Applicant: Zuma Beach IP Pty Ltd, Melbourne (AU)

(72) Inventors: Stuart Paul Berwick, Marina Del Rey, CA (US); Barry John Palmer, Balnarring Beach (AU)

(73) Assignee: Zuma Beach IP Pty Ltd, Melbourne (AU)

(21) Appl. No.: 15/682,420

(22) Filed: Aug. 21, 2017

Related U.S. Application Data
(63) Continuation-in-part of application No. PCT/AU2016/050117, filed on Feb. 22, 2016.
(60) Provisional application No. 62/417,201, filed on Nov. 3, 2016.

(30) Foreign Application Priority Data
Feb. 23, 2015 (AU) 2015900632
Mar. 27, 2015 (AU) 2015901112

(51) Int. Cl. H04N 5/265; G11B 27/038; H04H 60/04; H04N 5/232; H04R 3/00

(52) U.S. Cl. CPC H04N 5/265; H04N 5/23293; H04R 3/00; H04H 60/04; G11B 27/038; H04N 5/772

(57) ABSTRACT

Disclosed herein are methods of generating video data on a portable electronic device, the method comprising the steps of: the portable electronic device accessing pre-generated data representing a pre-generated video synchronized with pre-generated audio; the portable electronic device accessing user-generated content (UGC) data representing a user-generated photo or video generated by a camera of the portable electronic device; and the portable electronic device generating combined data representing a combined video that includes a portion of each of the pre-generated video, and the user-generated photo or video.

### CROSS-REFERENCE TO RELATED APPLICATIONS

The present application claims the benefit of priority to U.S. provisional patent application 62/417,201, filed Nov. 3, 2016, the contents of which are hereby incorporated by reference. The present application also claims the benefit of priority to International PCT Application No. PCT/AU2016/050117, filed Feb. 22, 2016, which includes claims of priority to AU Application No. 2015900632, filed Feb. 23, 2015, and AU Application No. 2015901112, filed Mar. 27, 2015, the contents of which are hereby incorporated by reference. and

### FIELD OF THE INVENTION

The present invention generally relates to apparatuses, devices, systems, machine-readable media, and methods for generation of combined videos such as by combining at least portions of a plurality of pre-existing images and/or videos.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Existing professional video-editing and generation packages used by movie studios, or video production houses, are generally inefficient and difficult to use for small-scale applications, e.g., users without technical training with hand-held portable electronic devices such as portable smartphones and tablets (which may be iPhones or iPads from Apple Inc, or Galaxy products from Samsung Group, or Lumia products from Microsoft Corporation).

Existing smartphone applications, or more generally, mobile web, (which may be known as “apps”) may allow for combination of video files on the smartphones; however, these applications are limited to simply concatenating existing files on the smartphone, and generation of richer videos incorporating images and/or video from more varied sources is slow and/or laborious and/or impossible.

Thus there exists a need in the art to address or ameliorate one or more disadvantages or limitations associated with the prior art, or to at least provide a useful alternative

### SUMMARY OF THE INVENTION

Various embodiments include a method of generating video data, comprising providing a Base Content Piece (BCP) and an Additional Content Piece (ACP), and incorporating the ACP into the BCP to generate the video data, wherein the video data is implemented by a device with at least one processor. In another embodiment, the video data is generated on a portable electronic device. In another embodiment, the video data is generated on a server. In another embodiment, the BCP comprises a pre-generated video and/or audio. In another embodiment, the BCP is a professional video. In another embodiment, the BCP is uploaded from another device. In another embodiment, the BCP is User Generated Content (UGC), and/or from the camera roll of that device. In another embodiment, the ACP is UGC. In another embodiment, the ACP comprises audio, video, still image, GIF, photo, or series of photos, or combinations thereof. In another embodiment, the ACP is uploaded from another device, including pre-generated and professionally generated content. In another embodiment, the ACP is from the camera roll of that device. In another embodiment, the ACP is video from a camera of the device. In another embodiment, the ACP can be added at any point in the time line of the BCP. In another embodiment, incorporating the ACP in the BCP replaces the audio or video or parts thereof to create the video data. In another embodiment, the incorporating step may be repeated several times by adding several iterations of BCP and ACP. In another embodiment, the video data creates a new type of brand activation that offers engagement and visibility across all social and messaging applications. In another embodiment, the brand activation is created for every user's share on any social or direct messaging platform. In another embodiment, the video data is used for one or more of the following purposes: education, instruction, recruitment, polling, human resources, evaluation, assessment, diagnosis, posting on a social network, posting on video hosting sites, chat messaging, and commentary on the BCP. In another embodiment, the method further comprises a Multi-Function Button (MFB). In another embodiment, the MFB offers functionality including Play, Stop, Record, Camera Viewfinder, Tap to Stop, or Play BCP, or combinations thereof In another embodiment, further comprising a timeline display of the BCP and ACP in the application screen. In another embodiment, further comprising a camera image display in the MFB. In another embodiment, a video is playing on the screen whilst a camera is open in the record button. In another embodiment, the MFB is used to create machine readable instructions for the further insertion of other ACP into the combined video data. In another embodiment, the MFB offers functionality of Tap and Hold to Record with Camera Viewfinder. In another embodiment, the ACP comprises live captured video and/or audio.

Other embodiments include a method of generating video data on a portable electronic device, or server, comprising the steps of the portable electronic device accessing pre-generated data representing a pregenerated video synchronized with pre-generated audio, the portable electronic device accessing user-generated content (UGC) data representing a user-generated photo or video generated by a camera of the portable electronic device, and the portable electronic device generating combined data representing a combined video that includes a portion of each of the pre-generated video, and the user-generated photo or video. In another embodiment, the method further comprises the portable electronic device accessing transition data representing a transition image or transition video, and/or generating the combined video data by including the transition image or transition video in the combined video data. In another embodiment, the generating step comprises generating a transition component from the BCP to the ACP, or from the ACP to the BCP, based on a transition shape in the transition image wherein one or more of the following apply wherein the transition image defines one or more two-dimensional (2D) shapes, wherein the transition shape includes a plurality of regions, wherein the transition image includes pixel values defining masks in the transition image, wherein the generating step includes a step of generating a masking transition between the user-generated video or image and the video based on the image mask, and/or wherein the portable electronic device accesses the transition data on the remote server system using a telecommunications network. In another embodiment, further comprising the step of generating intermediate transition data representing an intermediate transition video including a plurality of video frames based on the transition image, wherein the generating step includes a step of combining the intermediate transition video with at least the portion of each of the pre-generated video and the user-generated image or video. In another embodiment, the combined data represent a plurality of frames of the pre-generated video, a plurality of frames of the transition image or video, and a plurality of frames of the user-generated image or video. In another embodiment, the combined data comprises synchronization with pre-generated audio. In another embodiment, further comprising the device generating combined data by synchronizing at least a portion of pre-generated audio with each of the pre-generated video and user-generated photo or video. In another embodiment, further comprising the portable electronic device generating combined data by synchronizing at least a portion of user-generated audio from the UGC with each of the pre-generated video and the user-generated photo or video. In another embodiment, the transition is selected by machine readable instructions contained in the BCP. In another embodiment, further comprising a step of fading in the pre-generated audio over a fade-in duration at a start of the combined video to generate the combined data and/or including a step of fading out the pre-generated audio over a fade-out duration at an end of the combined video to generate the combined data. In another embodiment, further comprising a step of the portable electronic device cross-fading the pre-generated audio to the user-generated audio and/or crossfading the user-generated audio to the pre-generated audio, over at least one crossfade duration in at least one corresponding intermediate portion of the combined video to generate the combined data. In another embodiment, further comprising a step of accessing, on the portable electronic device or from the remote server system, watermark data representing a watermark image or video, and the generating step including the portable electronic device inserting the watermark image or video into the video data. In another embodiment, the watermark is inserted into at least a portion of the BCP, and/or at least a portion of the ACP. In another embodiment, the watermark is inserted onto any part of the video data.

Various embodiments include a method of generating video data, comprising a portable electronic device accessing pre-generated data representing a pre-generated video synchronized with pre-generated audio, the portable electronic device accessing user-generated content (UGC) data representing a user-generated photo or video generated by a camera of the portable electronic device, the portable electronic device accessing transition data representing a transition image, and the portable electronic device generating combined data representing a combined video that includes a portion of each of the pre-generated video, the user-generated photo or video, and the transition image, synchronized with at least a portion of the pre-generated audio. In another embodiment, further comprising the step of incorporating overlays or video effects into either the BCP or ACP. In another embodiment, the video effect or overlay is incorporated based on elements in the video data. In another embodiment, the video effect or overlay is incorporated based on the position of a face, person, or other object in the video data. In another embodiment, the face, person or other object in the video is being tracked regardless of whether the video is being used as part of the combined video data. In another embodiment, machine-readable media including machine-readable instructions that control one or more electronic microprocessors. In another embodiment, the machine-readable instructions are incorporated into the BCP. Other embodiments include an apparatus. Other embodiments include a system. Other embodiments include a portable device.

Other embodiments an apparatus, comprising a device capable of generating video data by incorporating an Additional Content Piece (ACP) into a Base Content Piece (BCP), and a Camera Viewfinder that allows the user to track their face and pre load masks as a video effect and/or overlay of the video data. In another embodiment, further comprising a means of having pre-defined sections that also include lenses and voices. In another embodiment, the means of having pre-defined sections is described in FIG. 10 herein. In another embodiment, further comprising a means of replacing audio and video allowing user to comment on the video. In another embodiment, the means of replacing audio and video is described in FIG. 11 herein.

Other features and advantages of the invention will become apparent from the following detailed description, taken in conjunction with the accompanying drawings, which illustrate, by way of example, various embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts, in accordance with embodiments herein, one embodiment of the customized video data disclosed herein. As shown in FIG. 1, the method described herein can be used to watch friends and influencers, enter competitions, record oneself into a video, and customize and share the video.

FIG. 2 depicts, in accordance with embodiments herein, a schematic diagram of a system for generating combined videos.

FIG. 3 depicts, in accordance with embodiments herein, a block diagram of software modules and data structures in the system.

FIG. 4 depicts, in accordance with embodiments herein, a diagram of components in the combined videos. The figure includes, in accordance with embodiments herein, a diagram of components that a combined video could include. As readily apparent to one of skill in the art, the diagram could also include vertical video, recording in and out, user audio, video stickers, drawing, text, audio modulation, filters & face masks.

FIG. 5 depicts, in accordance with embodiments herein, a flowchart of a method of video generation performed by the system. As readily apparent to one of skill in the art, the flowchart can also include GIF applications.

FIG. 6 depicts, in accordance with embodiments herein, flowcharts of examples of generating a combined video. FIGS. 6A to 6C depicts, in accordance with embodiments herein, a flowchart of a method of generating a combined video performed by the system.

FIG. 7 depicts, in accordance with embodiments herein, details of a portion of an implementation using Objective C. Also referred to herein as Appendix A.

FIG. 8 depicts, in accordance with embodiments herein, details of a portion of an implantation using Apple's “Core Image” Application Programming Interface (API). Also referred to herein as Appendix B.

FIG. 9 depicts, in accordance with embodiments herein, one embodiment of the customized video data enclosed herein. As shown in FIG. 9, the method described herein can be used to record using the MFB ACP into a BCP. The video data then loops and FIG. 1b shows recording again over both the BCP and already recorded ACP. In one embodiment, the ACP may include audio, video or a combination of both. In another embodiment, the ACP includes photographs and/or Gifs.

FIG. 10 depicts, in accordance with embodiments herein, one embodiment of the customized video data enclosed herein. As shown in FIG. 10, the method described herein can be used to set points in the BCP that record ACP as determined by timing points in 106 the Upload Portal. As shown in FIG. 10 the lenses and voices are also determined by these timing points in 106 the Upload Portal. The MFB has the sense pre-loaded so that when the ACP point is reached the lense and voice effect is immediately available without the need to load them. As shown in FIG. 10 when the MFB is held the BCP is playing ‘video on video’ on top of the recording of the ACP.

FIG. 11 depicts, in accordance with embodiments herein, a diagram of an example of the means to replacing audio & video allowing user to comment on the video.

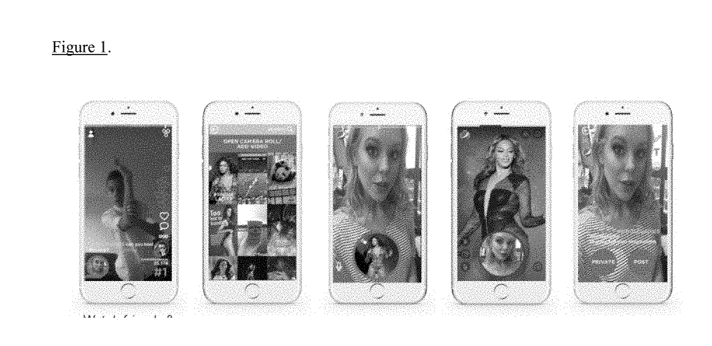

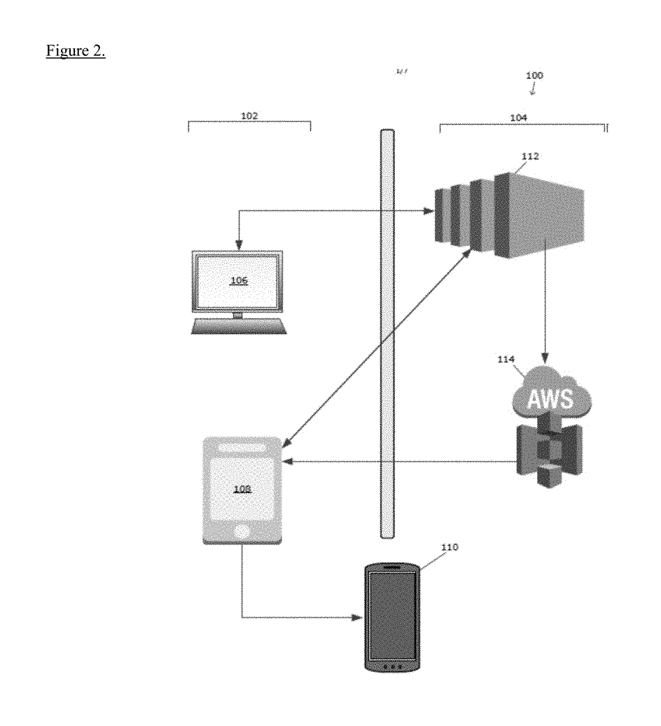

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials described.

As used herein, the term “UGC” refers to a user generated data. As used herein, the term “EGC” refers to an externally generated data, or Event Generated Content. As used herein, the term “BCP” refers to a base content piece. As used herein, the term “ACP” refers to an additional content piece. In some embodiments, Additional Content Piece(s) (ACP) can be User Generated Content (UCG) including audio or video, a combination of both or a still photo and/or a GIF. In some embodiments, the Base Content Piece (BCP) is data obtained from a pre-generated video of any length, or a pre-generated audio. As used herein, the term “BCP” also includes Event Generated Content, or “EGC”.

As described herein, in accordance with various embodiments herein, the inventors have created a unique marketing solution for brands and content owners to engage directly with the co-creation generation of users and customers. In accordance with various embodiments herein, this can include a unique tool for Question and Answer formats. This could include, for example, offering Recruitment and Insurance companies, medical diagnostic groups, pollsters, governments, training groups, Human Resources, language and learning companies, to create scripted BCP content for a target recipient/customer to input their audio and video responses, providing the company and recipient with remote access to each other, with the content able to be archived for an ongoing record and with responder's input being flexible across time and geographic zones and not dependent on one-to-one real time engagement (for example, Skype). Video is essential to communication and self-expression. So, for example, in an another embodiment video replaces texting and calling. The inventors have created, for example, a unique video messaging and communication technology. In another embodiment, the inventors have created a unique mobile application that enables users to integrate themselves into professional videos. This enables moving beyond impressions to a new type of brand activation that offers deep engagement and visibility across all social and messaging applications.

The new application, which the inventors refer to as “Kombie,” has real time discontinuous video and audio clip recording, where one piece of content can be recorded with another piece being recorded at a later point of a timeline without having to stop the playback engine that is playing the material over which a recording is being made. In one illustrative example, the example the video is playing for the user to hit a multi function button to record himself or herself into the content. Thus, Kombie provides a novel continuous record in and out and play with content.

In one embodiment, disclosed herein is a method of generating a video data implemented by a server and at least one processor, wherein the video data comprises: a base content piece (BCP); an additional content piece (ACP); and wherein the ACP is incorporated in the BCP to generate the video data. In one embodiment, the video data is generated on a portable electronic device. In one embodiment, the BCP comprises a pre-generated video or audio. In one embodiment, the BCP is a professional video. In one embodiment, the BCP is uploaded to the server from another server. In one embodiment, the BCP is uploaded to the server from an electronic device or camera roll. In one embodiment, the BCP can be recorded live via the device camera. In one embodiment, the ACP is user generated content. In one embodiment, the ACP comprises audio, video, or a still photo, or combinations thereof. In one embodiment, the ACP is uploaded to the server from an electronic device or camera roll. In one embodiment, the ACP can be added at any point in the time line of BCP. In one embodiment, incorporating the ACP in the BCP replaces the audio or video or parts thereof to create the video data. In one embodiment, the incorporating step may be repeated several times by adding several iterations of BCP and ACP. In one embodiment, the video data creates a new type of brand activation that offers engagement and visibility across all social and messaging applications. In one embodiment, the brand activation is created for every user's share on any social or direct messaging platform. In one embodiment, the video data is used for educational purpose. In another embodiment, such as might be used for recruitment, medical, and/or polling purposes, for example, the BCP is uploaded to the device either via verified access for a specific customer or alternatively, available to the general public without restriction, or limited restriction-Geo-Fenced. In another embodiment, the Questions/Statements are input(ed) as BCP by the company to create a questionnaire or diagnostic piece or educational piece, with a following “blank” content piece left available for the customer or polled person to add their UGC. The space for UGC input, for example, can be fixed to a time limit or extended to a maximum UGC time input. This UGC can be archived and reviewed by the agent who has created the BCP. In another embodiment, the technology is packaged as a software development kit, an Application programming interface (API). or Software Development Kit (SDK). In one embodiment, this technology can be used in livestreaming. In one embodiment, the video is playing on the screen whilst the camera is open in the record button. In one embodiment this technology can be used as communication.

Overview.

In one embodiment, described herein is a method for generating a combined video, the method including steps of: a portable electronic device accessing, on the portable electronic device, user-generated content (UGC) data that represent a user-generated image or video; the portable electronic device accessing, from a remote server system, externally generated content (EGC) data that represent a pre-generated video including pre-generated audio; the portable electronic device accessing, on the portable electronic device or from the remote server system, transition data that represent a transition image or video; and the portable electronic device generating combined data representing a combined video by combining at least a portion of each of the user-generated image or video and the pre-generated video.

The generating step may include the portable electronic device synchronizing the user-generated image or video with at least a portion of the pre-generated audio. In another embodiment, the generating step may include “blank” spaces in which to record UGC, these can be of a be fixed time period. The blank spaces, for example, need not have any discernible video and audio content, viewed as a blank silent piece, alternatively, there can be media present that instructs users what to do—for example, please add your response here, keeping it to a minimum 30 seconds, or it may prompt the user to record certain events—please record a video of the car damage here.

The method may include a step of the portable electronic device storing the UGC data on the device using a camera of the device.

The method may include a step of the portable electronic device fading in the pre-generated audio over a fade-in duration at a start of the combined video to generate the combined data. The method may include a step of the portable electronic device fading out the pre-generated audio over a fade-out duration at an end of the combined video to generate the combined data. The method may include a step of the portable electronic device cross-fading the pre-generated audio to the user-generated audio, and/or cross-fading the user-generated audio to the pre-generated audio, over at least one cross-fade duration in at least one corresponding intermediate portion of the combined video to generate the combined data.

The method may include a step of the portable electronic device accessing, on the portable electronic device or from the remote server system, watermark data representing a watermark image or video, and the generating step may include the portable electronic device inserting the watermark image or video into the combined video. The watermark may be inserted into at least a portion of the pre-generated video, and/or at least a portion of the user-generated image or video. The watermark image or video may be placed over the user-generated video or image. The watermark image or video may be anywhere on at least one portion of the user-generated image or video and/or on the pre-generated video. Alternatively, the watermark may be inserted onto any part of the video data.

The method may include a step of generating intermediate UGC data representing an intermediate UGC video including a plurality of video frames based on the user-generated image, and the generating step may include a step of combining the intermediate UGC video with at least the portion of the pre-generated video.

The method may include a step of generating intermediate transition data representing an intermediate transition video including a plurality of video frames based on the transition image, and the generating step may include a step of combining the intermediate transition video with at least the portion of each of the pre-generated video and the user-generated image or video.

The method may include a step of generating intermediate watermark data representing an intermediate watermark video including a plurality of video frames based on the watermark image, and the generating step may include a step of combining the intermediate watermark video with at least the portion of each of the pre-generated video and the user-generated image or video.

The combined data may represent a plurality of seconds of the pre-generated video, a plurality of seconds of the transition image or video, and a plurality of seconds of the user-generated image or video, synchronized with the pre-generated audio. The UGC data may represent a locally stored video or a locally stored image on the portable electronic device. The UGC data may be an image file or a video file. The UGC image may be a photograph. The transition data may represent a transition video or a transition image. The method may include steps of accessing the EGC data and the transition data on the remote server system using a telecommunications network.

The transition image may define one or more two-dimensional (2D) and/or three-dimensional (3D) shapes.

The portable electronic device may be a smartphone or tablet computer with a communications module that communicates over the Internet, e.g., using a WiFi or cellular telephone protocol. The portable electronic device is a form of physical, electronic apparatus, and acts as a component in a computer system that includes other components (including the remote server) in electronic communication with each other. The steps of the methods described herein are performed under the control of one or more electronic microprocessors that follow machine-readable instructions stored on machine-readable media (e.g., hard disc drives).

The remote server system may include a content management system (CMS) that provides access to the stored EGC data.

Also described herein is a method of generating video data, the method including steps of: a portable electronic device accessing pre-generated data representing a pre-generated video synchronized with pre-generated audio; the portable electronic device accessing user-generated content (UGC) data representing a user-generated photo or video generated by a camera of the portable electronic device; the portable electronic device accessing transition data representing a transition image; and the portable electronic device generating combined data representing a combined video that includes a portion of each of the pre-generated video, the user-generated photo or video and the transition image, synchronized with at least a portion of the pre-generated audio.

The generating step may include the portable electronic device generating a transition component from one of the pre-generated video to the user-generated photo or video, or from the user-generated photo or video to the pre-generated video, based on a shape in the transition image. The shape may include a plurality of regions. The transition image may include pixel values defining masks in the transition image. The generating step may include a step of generating a masking transition between the user-generated video or image and the video based on the image mask. In embodiments, the transition is a transparent image (PNG) or video (MP4) that is uploaded to the CMS. This image may be converted into a corresponding video, as described hereinafter, e.g., a 2-second key frame animation.

The described methods may allow for one or more of:
combining the two pieces of media content (the UGC and the EGC) directly on the device, where one is delivered to the user and one created by the user, thus giving the user the ability to add their content to content delivered to them (e.g., using Apple's iOS frameworks as described hereinafter, or HTML5 for Web, or Java and C++ for Android operating systems);
combining the two pieces of media content on a server (remote from the device) using Adobe's “Flash” platform, and converting to a device-friendly format (e.g., “MP4” format) prior to transmitting the combined video to another device for sharing;
the transition between the two pieces of content provide a branded media piece using a brand image or a brand video pre-selected and delivered via the remote server system; and
rapid and easy-to-use sharing of pre-existing footage that the user wishes to share, and the footage may be quality video having pre-generated high-quality audio, that may associate the user with a live event or location.

System 100

As shown in FIG. 2, a system 100 for generation of combined videos includes a client side 102 and a server side 104. The client side 102 interacts with at least one user and at least one administrator of the system 100. The server side 104 interacts with the client side 102. The client side 102 sends data to, and receives data from, the server side 104.

The administration portal 106 sends (or uploads) event data and event media data from the client side 102 to the server side 104 based on input from the administrator. The uploaded event data and event media may represent the event name, date and location.

The client side 102 includes an administration portal 106 that receives analytics data and event data from the server side 104 for use by the administrator. The analytics and event data may represent any one or more of: time, date, location, number of pieces of content, number of views, number of shares, networks shared to, number of people ‘starring’ the event and social profile of this user.

The upload portal 106, which for example, also includes clips being uploaded from a phone to the server, allows the administrator to create the events, upload the pre-selected official content, and view analytics based on the analytics data.

The client side 102 includes a portable electronic device 108 (which is a form of portable electronic apparatus) that allows the user to interact with the system 100. The device 108 allows the user to create combined videos, and to share the combined videos. The device 108 sends (or uploads) the combined videos to the server side 104. The device 108 receives event data representing the relevant events from the server side 104. The device 108 receives media data representing externally generated content (EGC) from the server side 104. The device 108 shares the combined videos by sending (or publishing) the combined videos or links (which may be universal resource locators, URLs) to the combined videos to other devices 110 or servers which may be associated with social network systems (which may include systems provided by Facebook Inc, Twitter Inc and/or Instagram Inc).

The server side 104 includes a plurality of remote server systems, including one or more data servers 112 and one or more media content servers 114. The media content servers 114 provide the content management system (CMS).

The data servers 112 may be cloud data servers (e.g., provided by Amazon Inc) that send the data to, and receive the data from, the administration portal 106, and receive the data from, and send non-media content data to, the user device 108. The non-media data represent locations of the EGC data, and the transition data, which are stored in the media servers 114.

The media servers 114, which may also be cloud servers, receive media data (representing images and videos) including the EGC data, and any remote transition data and watermark data, from the data servers 112 for rapid sending (or provisioning) to the user device 108.

On the client side 102, the administration portal 106 may be a Web client implemented in a standard personal computer, such as a commercially available desk-top or laptop computer, or may be a portable mobile device such as iPhone or Android device.

The user device 108 may include the hardware of a commercially available smartphone or tablet computer or laptop computer with Internet connectivity. The user device 108 includes a plurality of standard software modules, including an operating system (e.g., iOS from Apple Inc., or Android OS from Google Inc). The herein-described methods executed and performed by the user device 108 are implemented in the form of machine-readable instructions of one or more software components or modules stored on non-volatile (e.g., hard disk) computer-readable storage in the user device 108. The machine-readable instructions control the user device 108 using operating system commands. The user device 108 includes a data bus, random access memory (RAM), at least one electronic computer processor, and external computer interfaces. The external computer interfaces include user-interface devices, including output devices and input devices. The output devices include a digital display and audio speaker. The input devices include a touch-sensitive screen (e.g., capacitive or resistive), a microphone and at least one camera. The external interfaces include network interface connectors that connect the user device 108 to a data communications network (e.g., a cellular telecommunications network) and the Internet.

The boundaries between the modules and components (which may also be referred to as “classes” or “methods”, e.g., depending on which computer-language is used) are exemplary, and alternative embodiments may merge modules or impose an alternative decomposition of functionality of modules. For example, the modules discussed herein may be decomposed into sub-modules to be executed as multiple computer processes, and, optionally, on multiple processors in the user device 108. Moreover, alternative embodiments may combine multiple instances of a particular module or sub-module.

Furthermore, the operations may be combined or the functionality of the operations may be distributed in additional. Alternatively, such actions may be embodied in the structure of circuitry that implements such functionality, such as the micro-code of a complex instruction set computer (CISC), reduced instruction set computer (RISC), firmware programmed into programmable or erasable/programmable devices, the configuration of a field-programmable gate array (FPGA), the design of a gate array or full-custom application-specific integrated circuit (ASIC), or the like.

On the server side 104, the data servers 112 may be Amazon data servers and databases, and the media-data servers 114 may include the Amazon “S3” system that allows rapid download of large files to the user device 108.

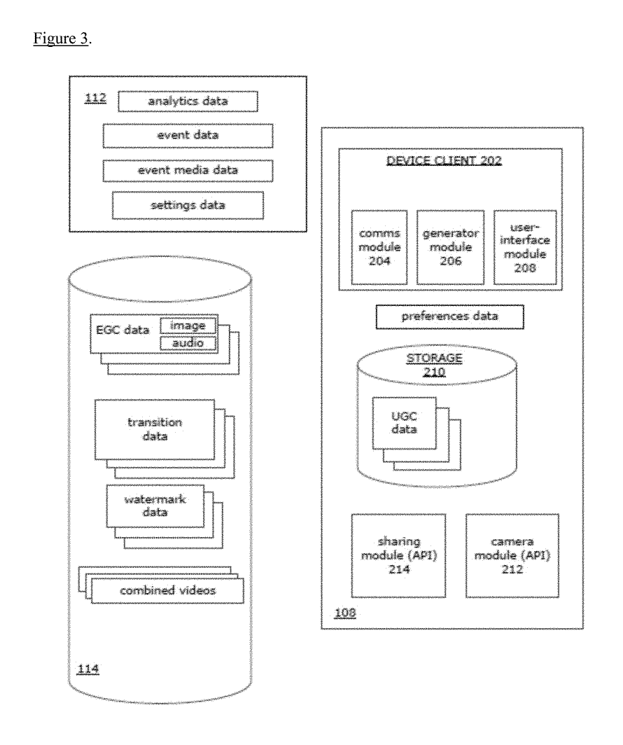

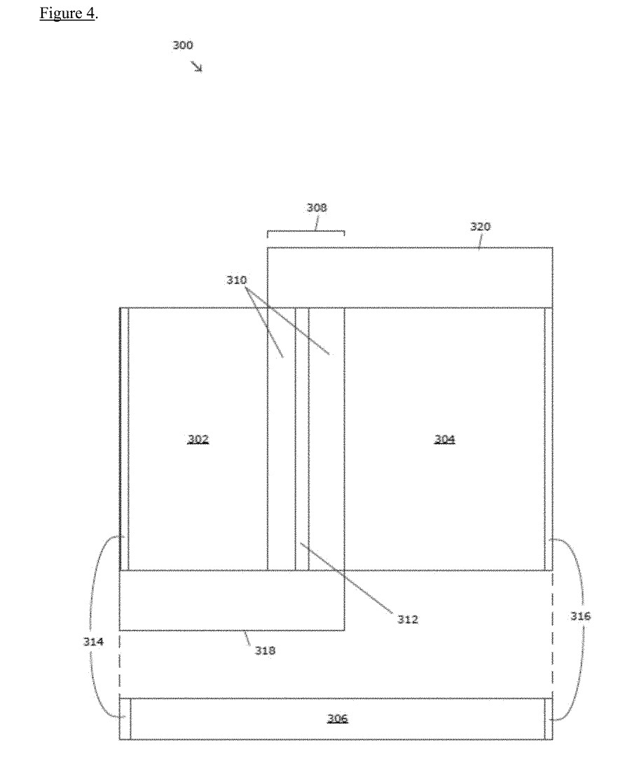

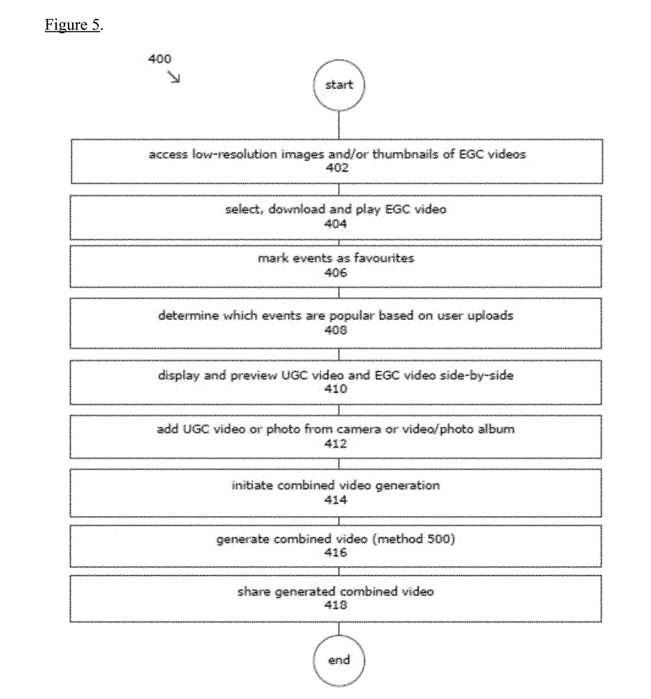

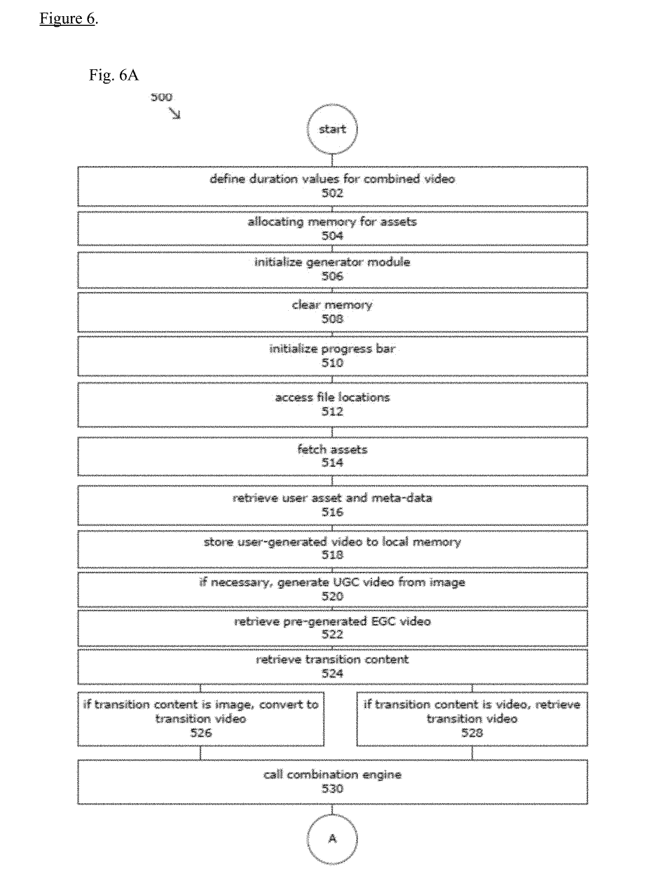

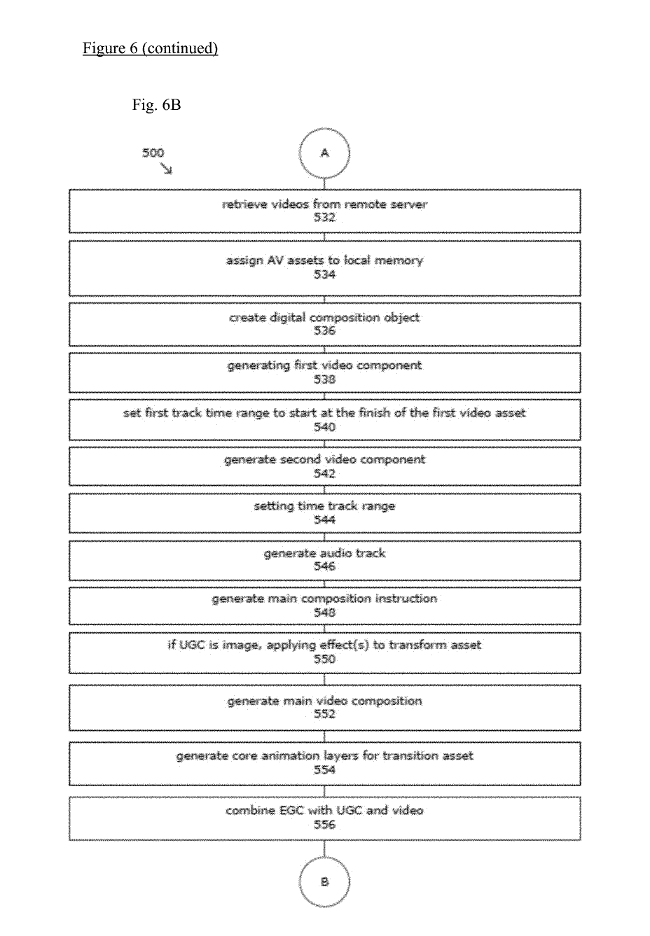

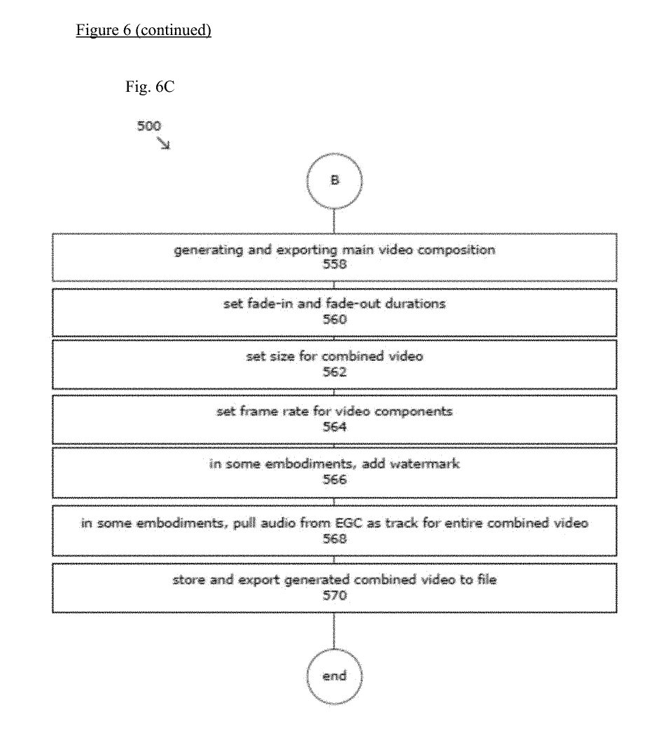

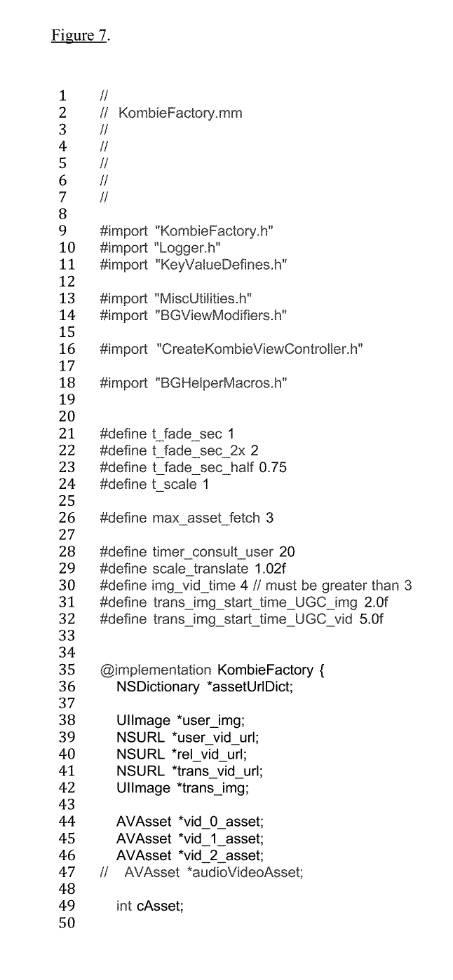

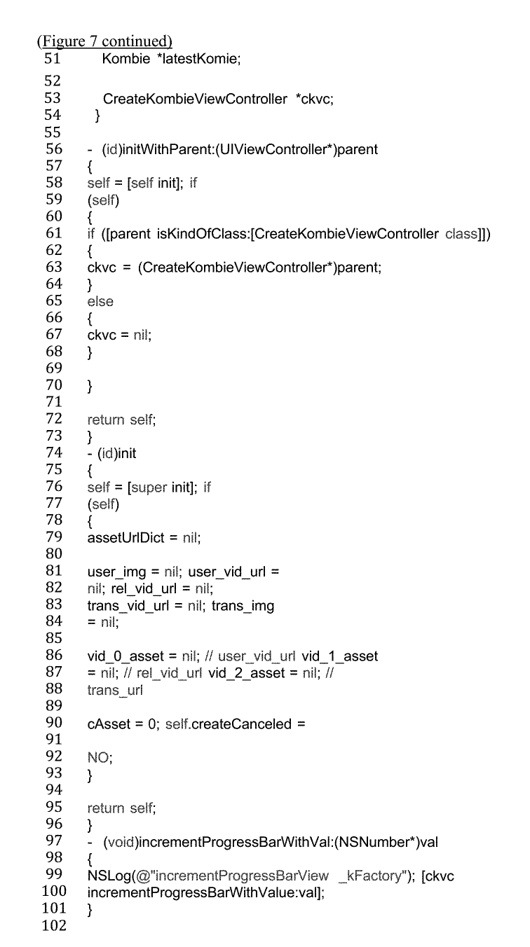

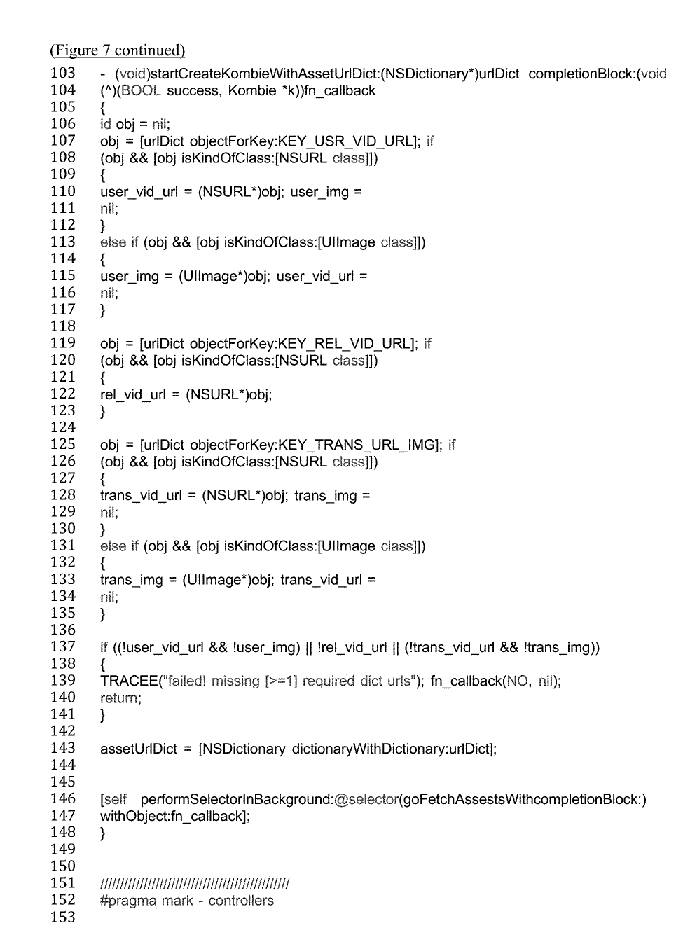

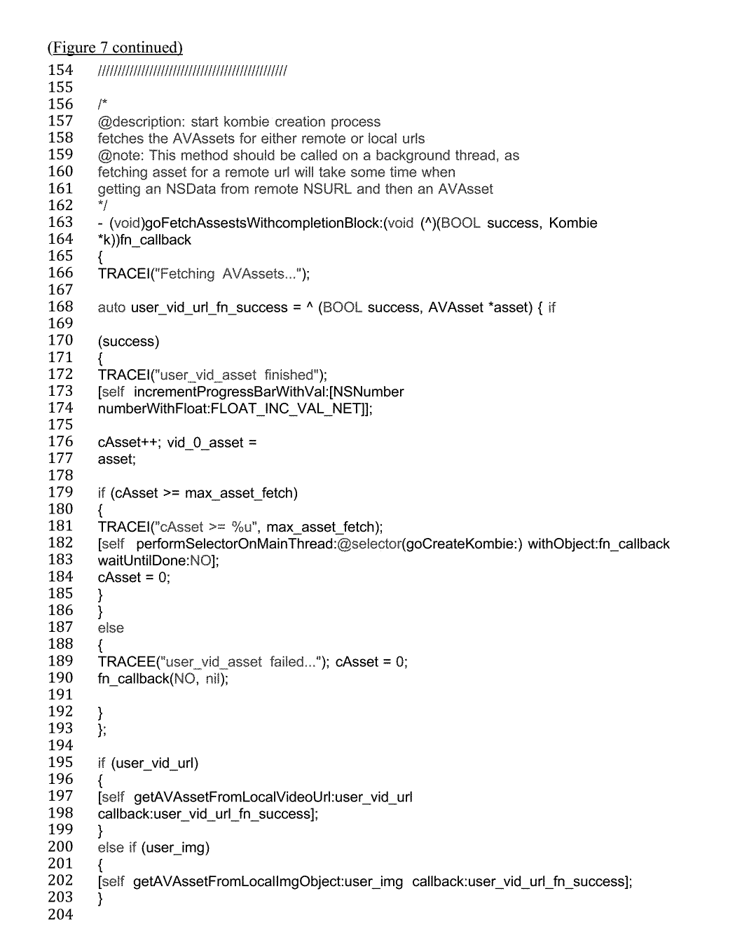

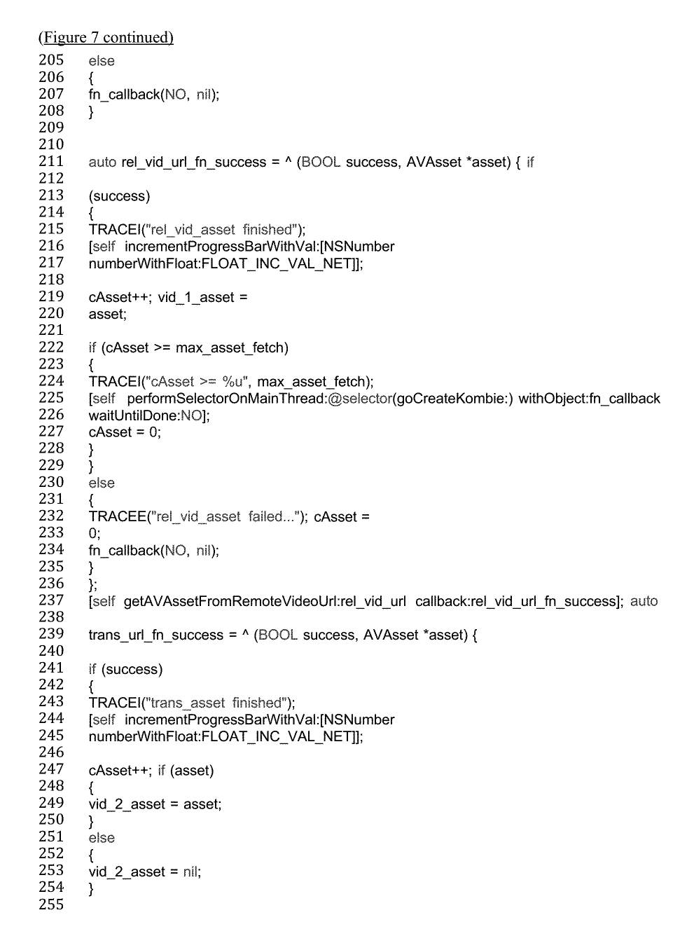

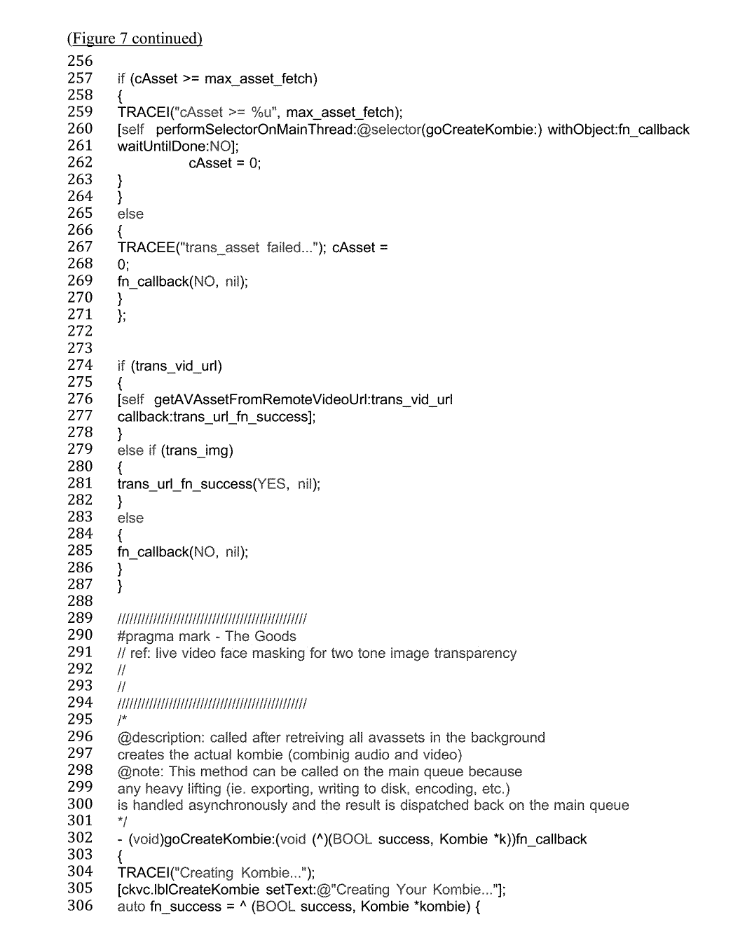

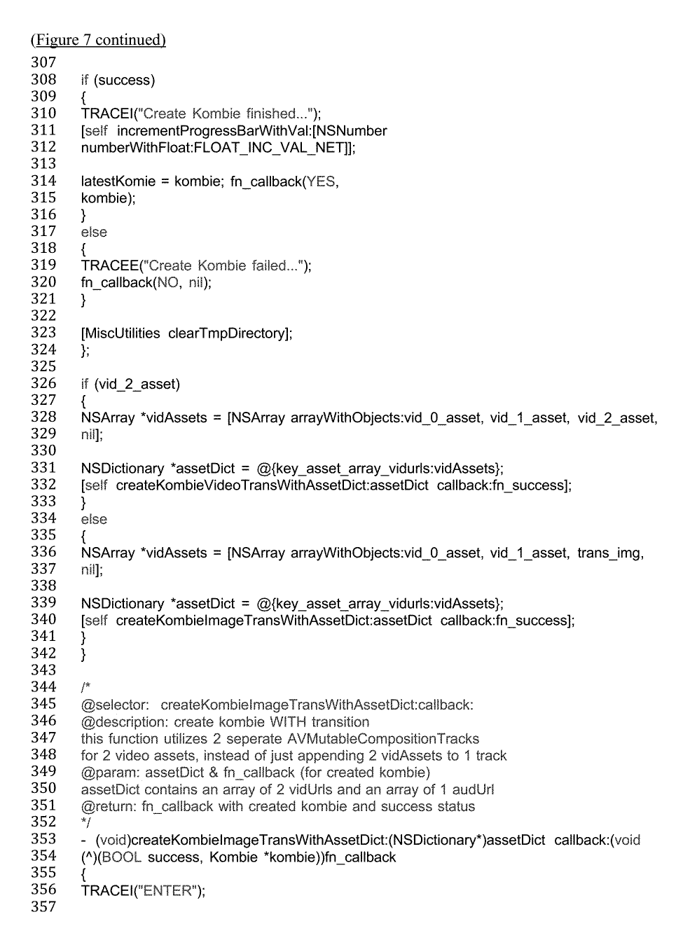

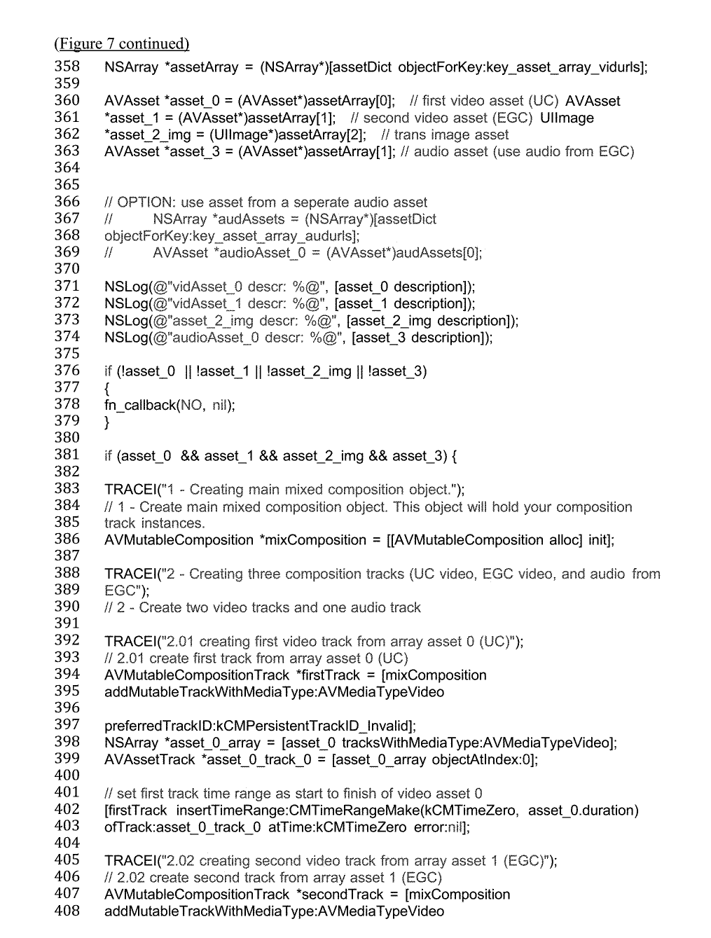

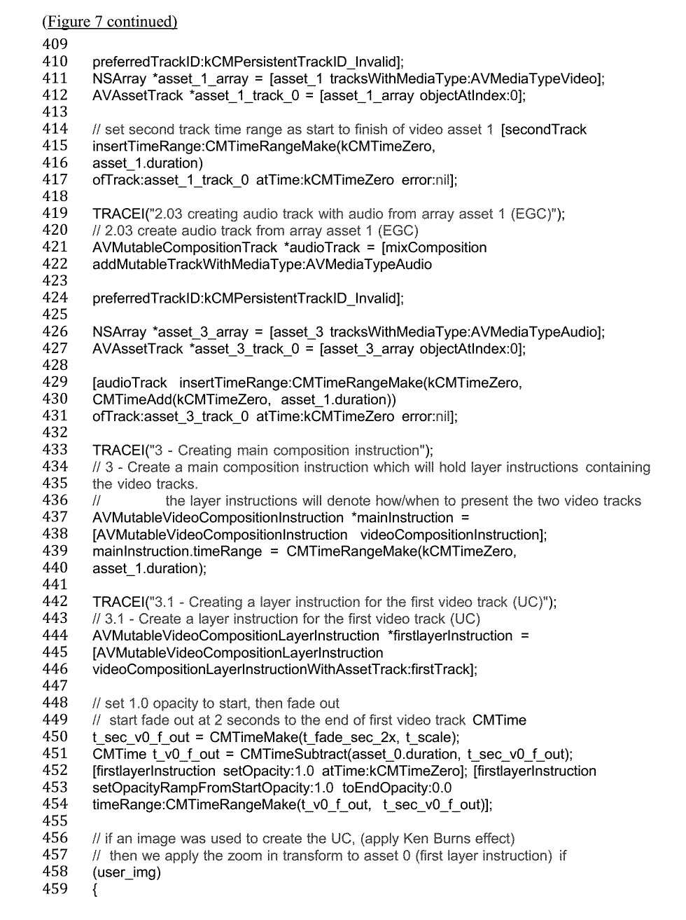

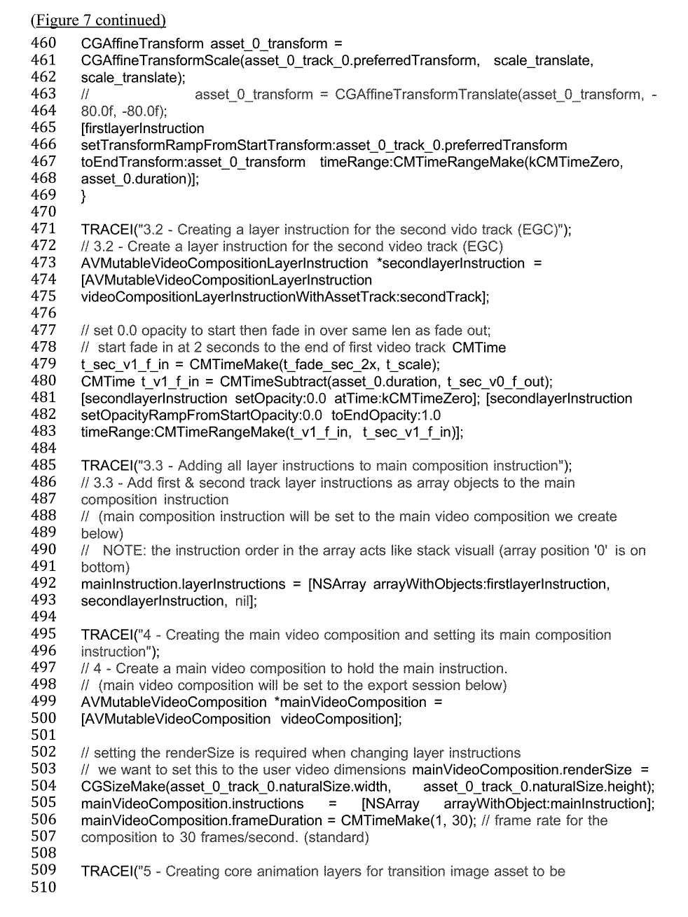

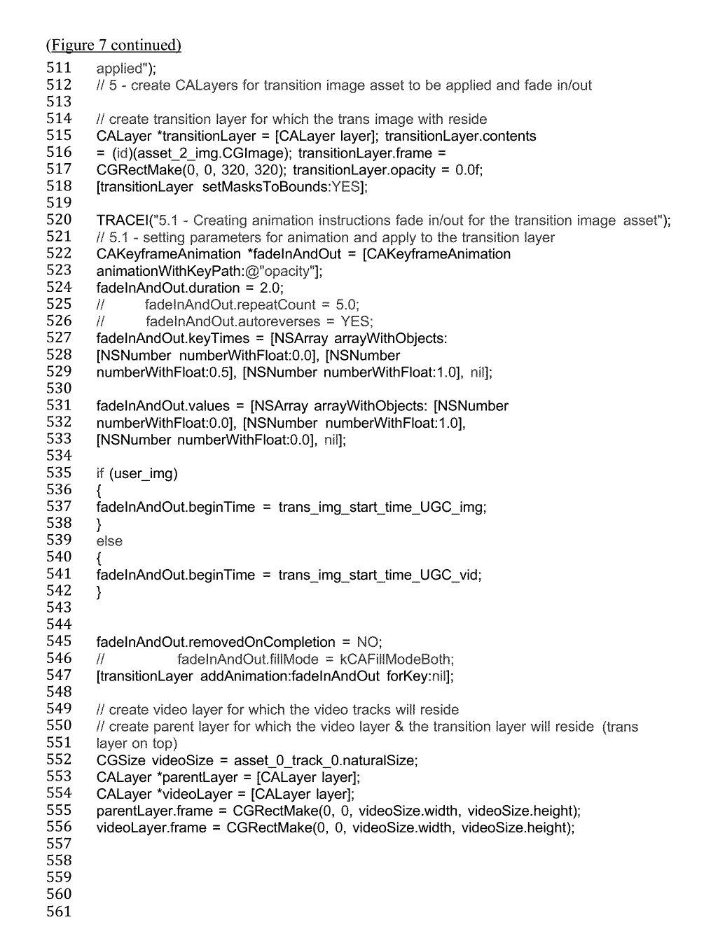

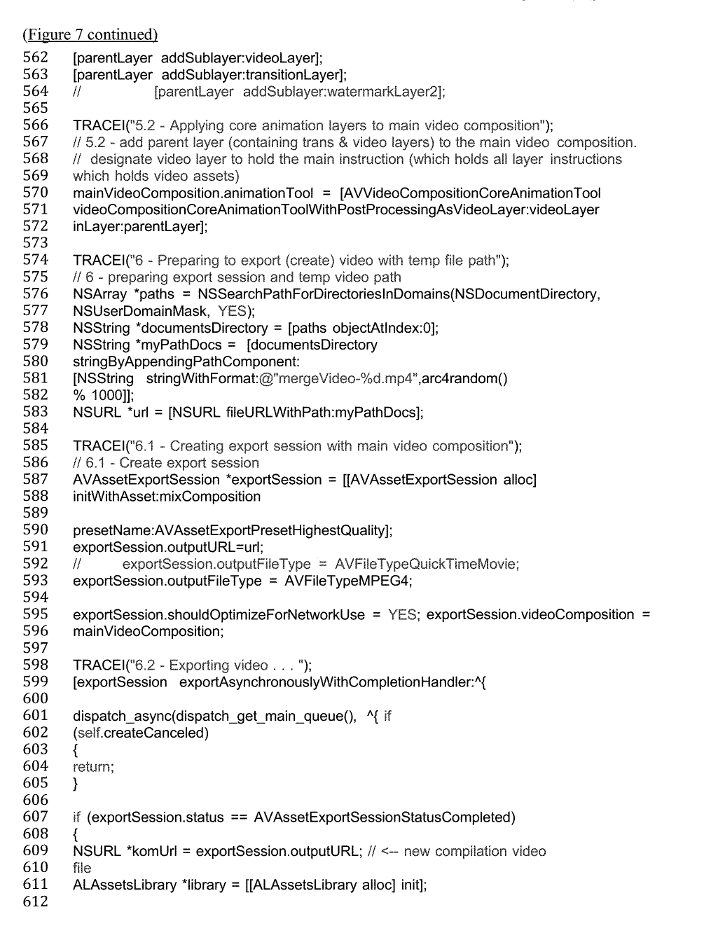

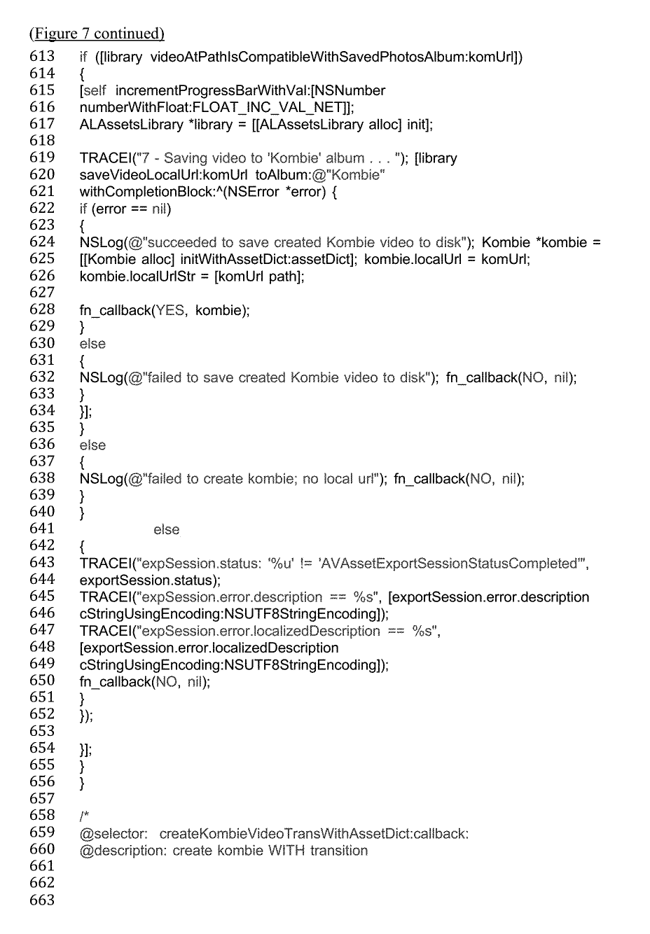

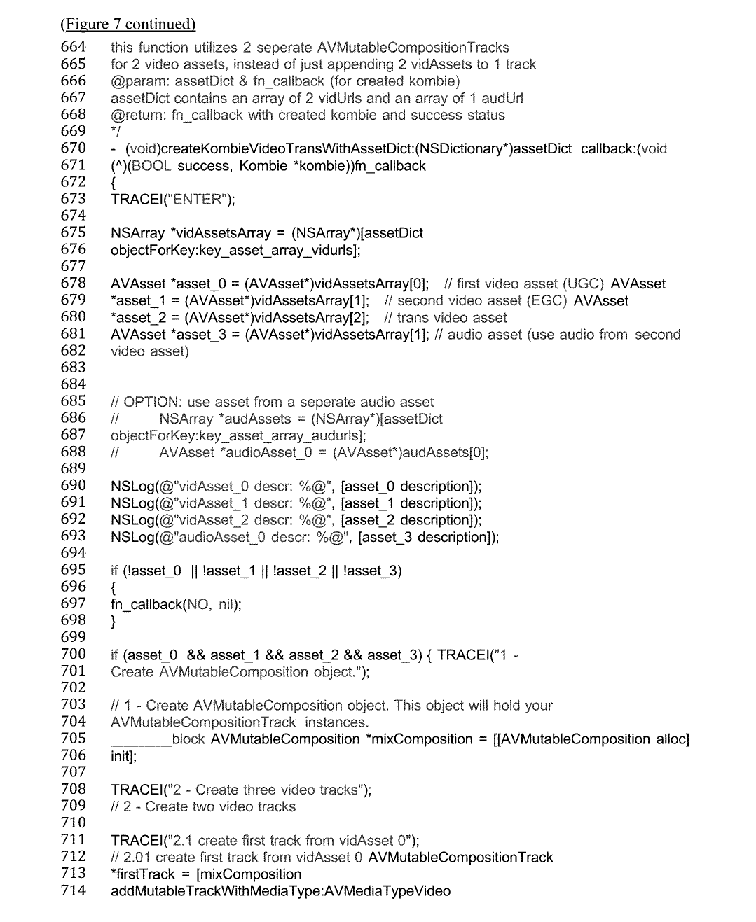

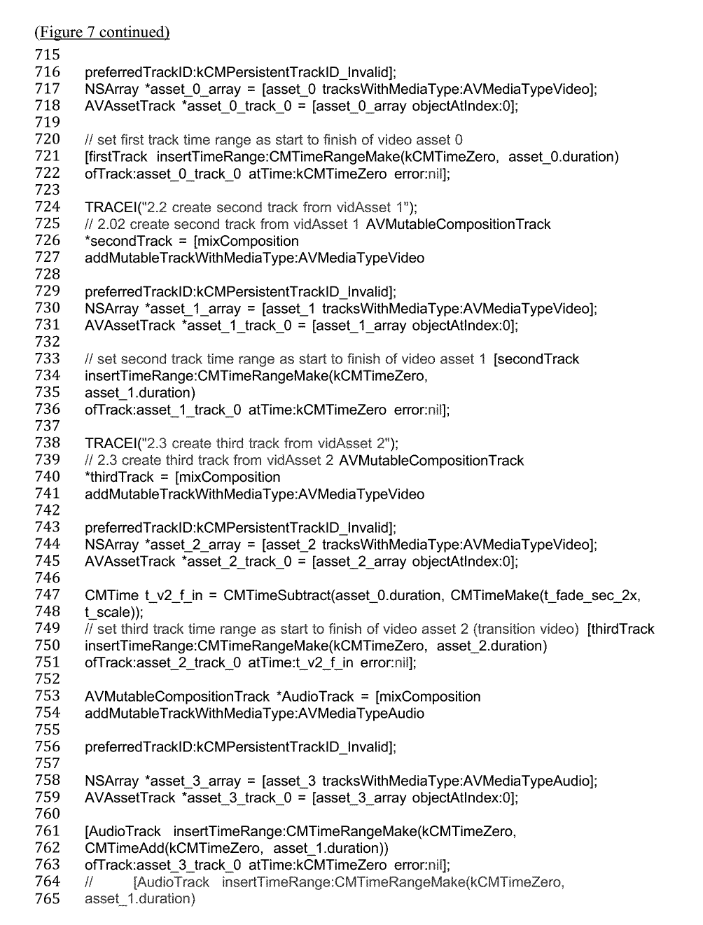

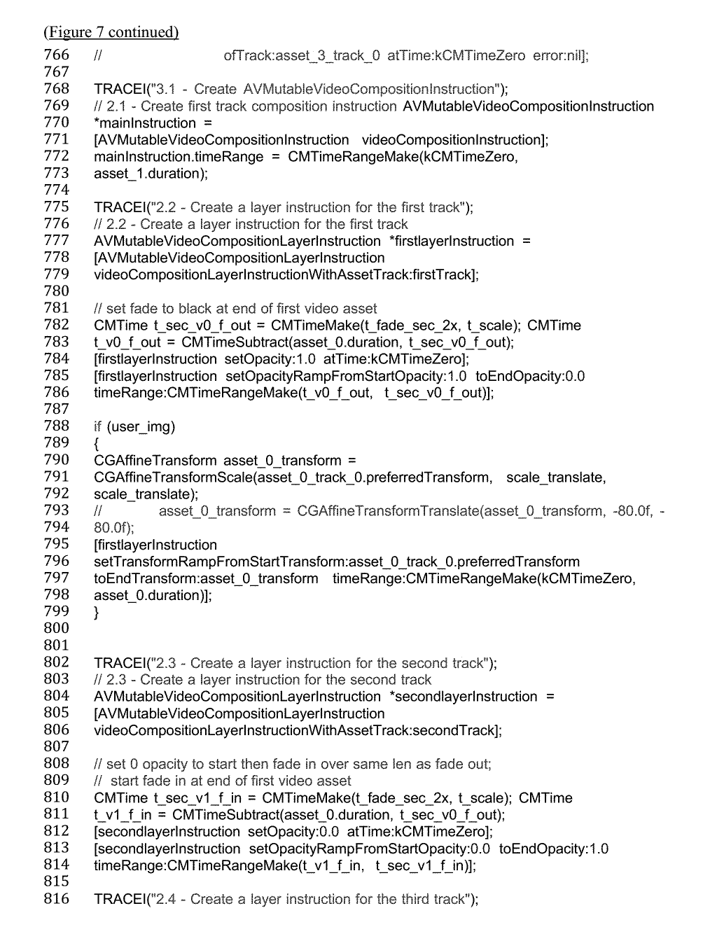

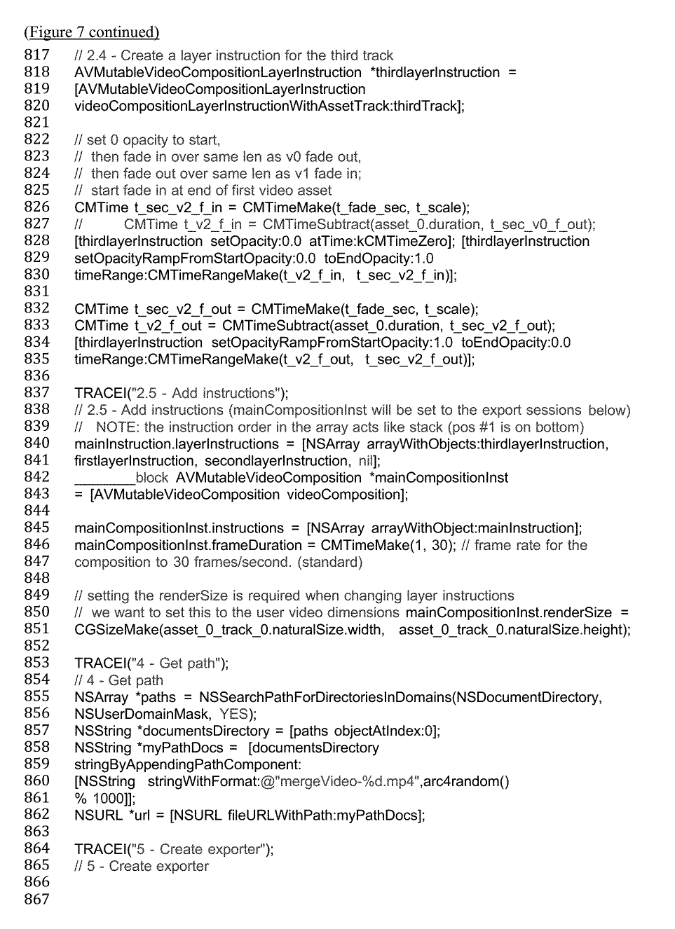

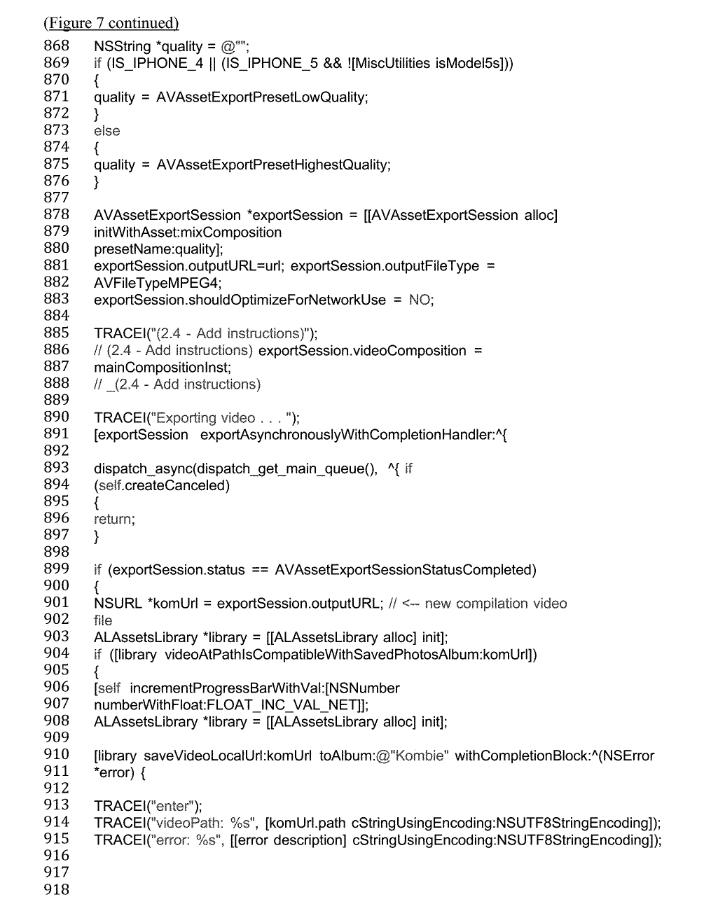

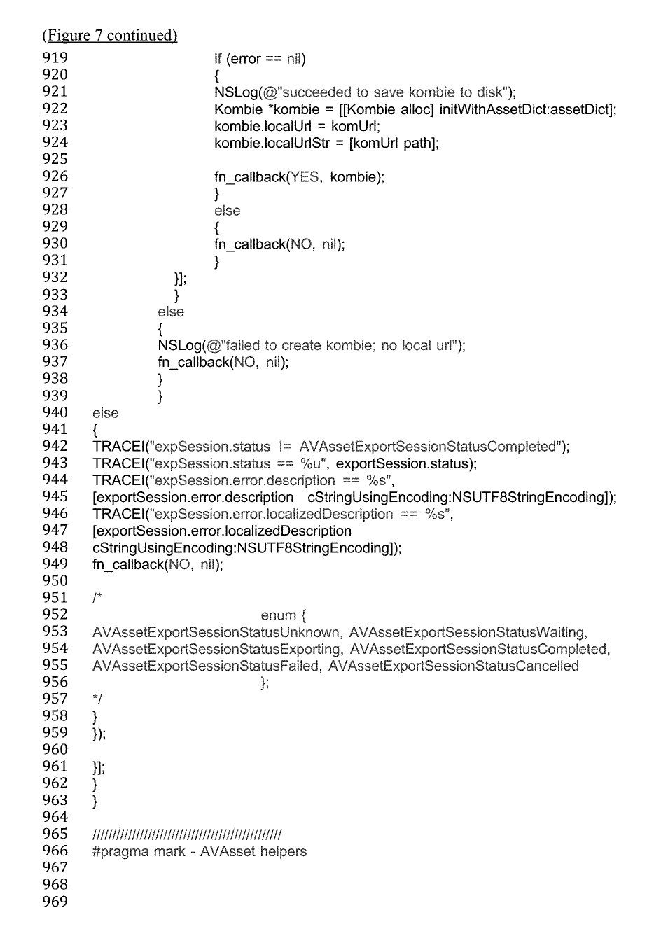

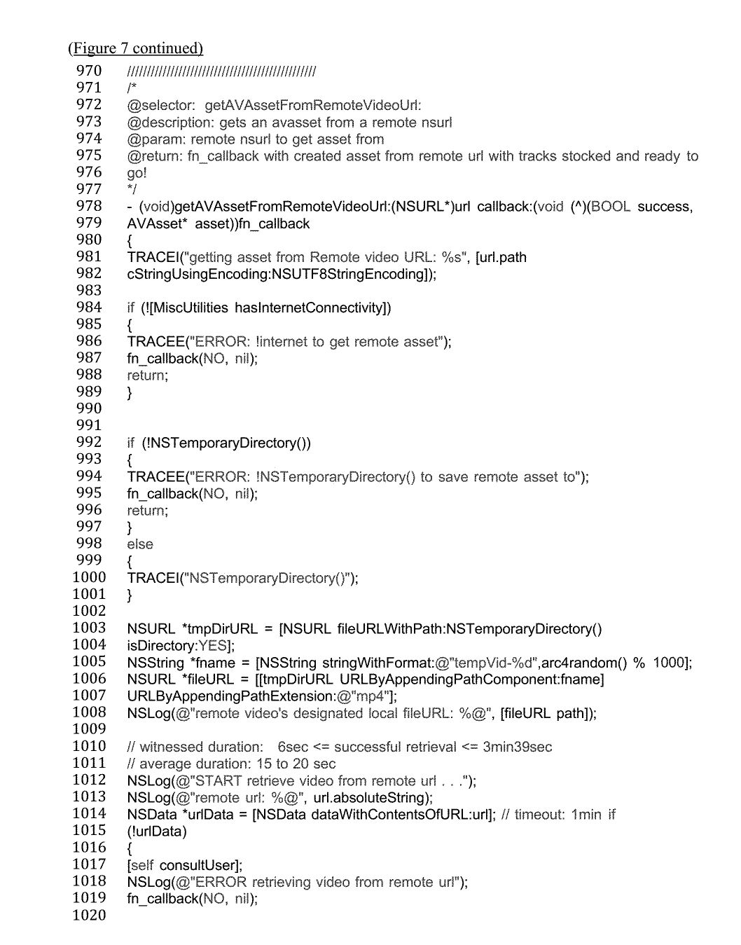

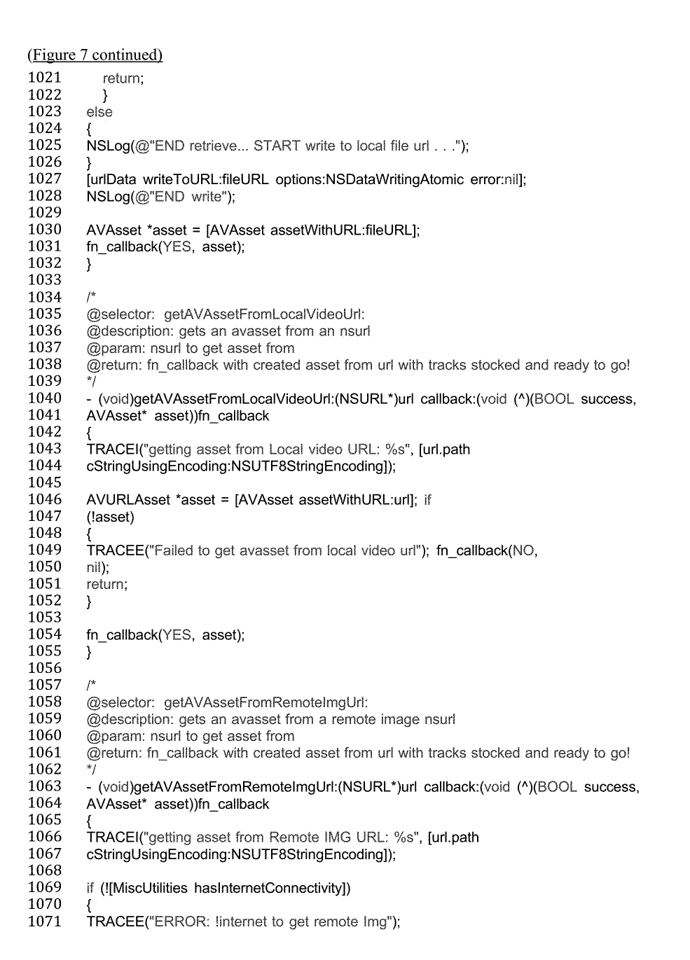

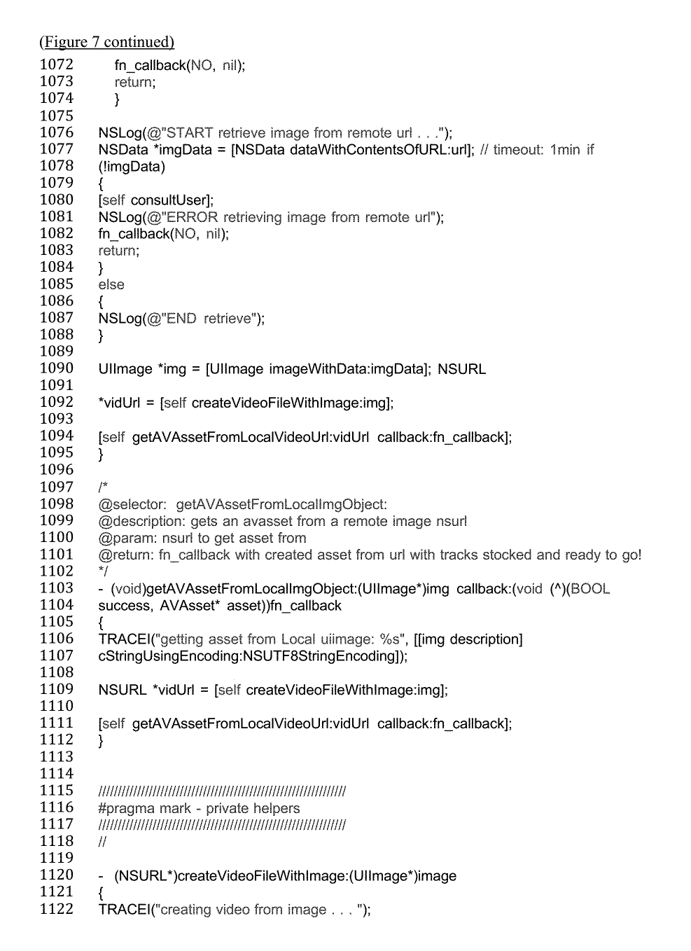

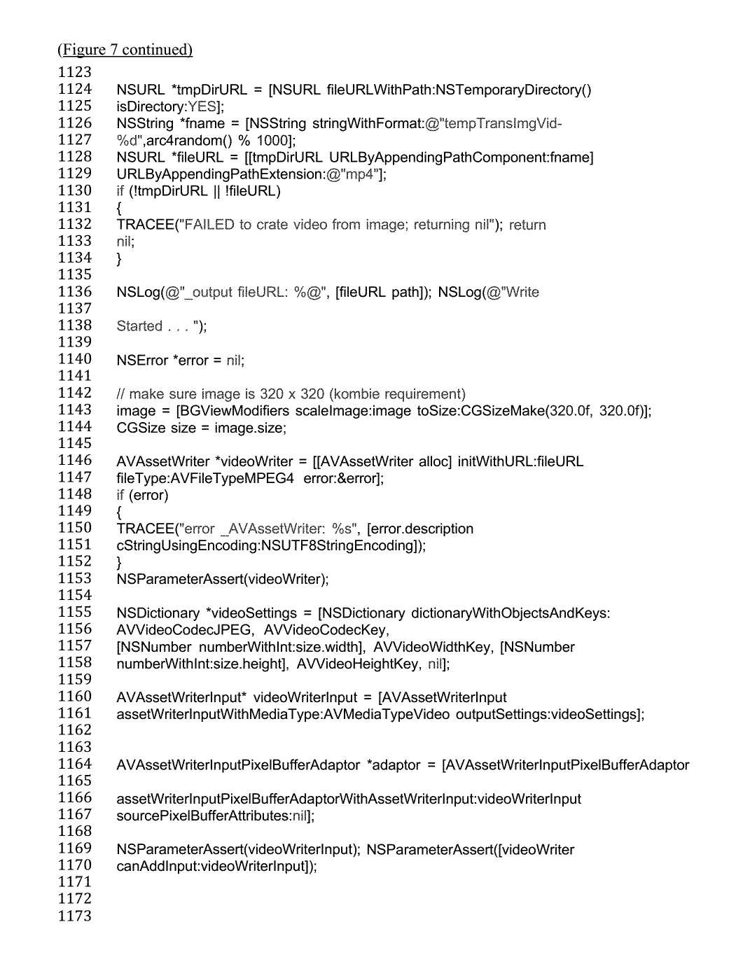

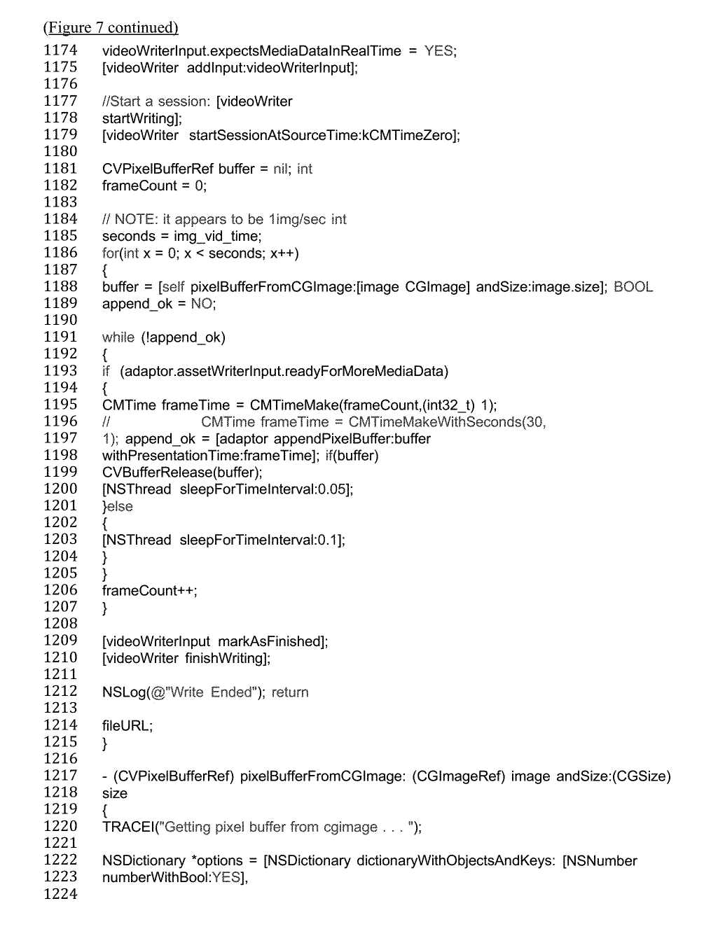

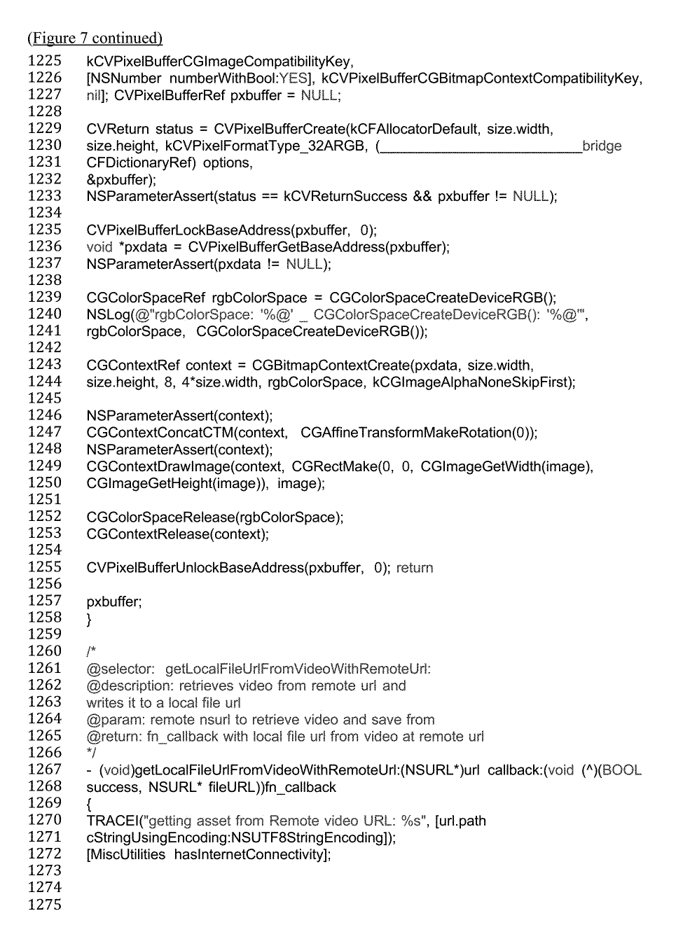

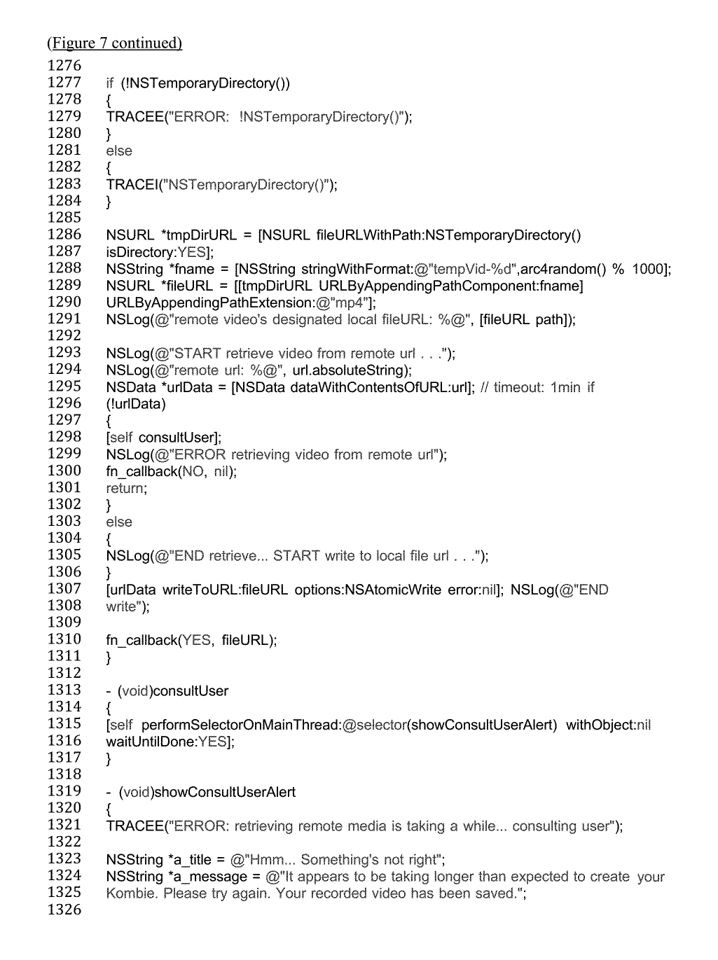

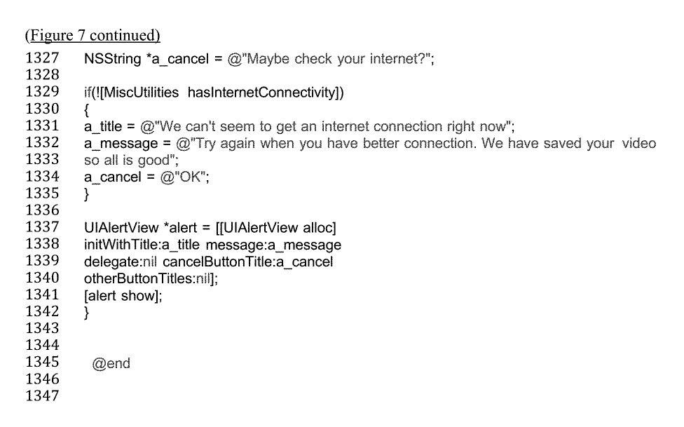

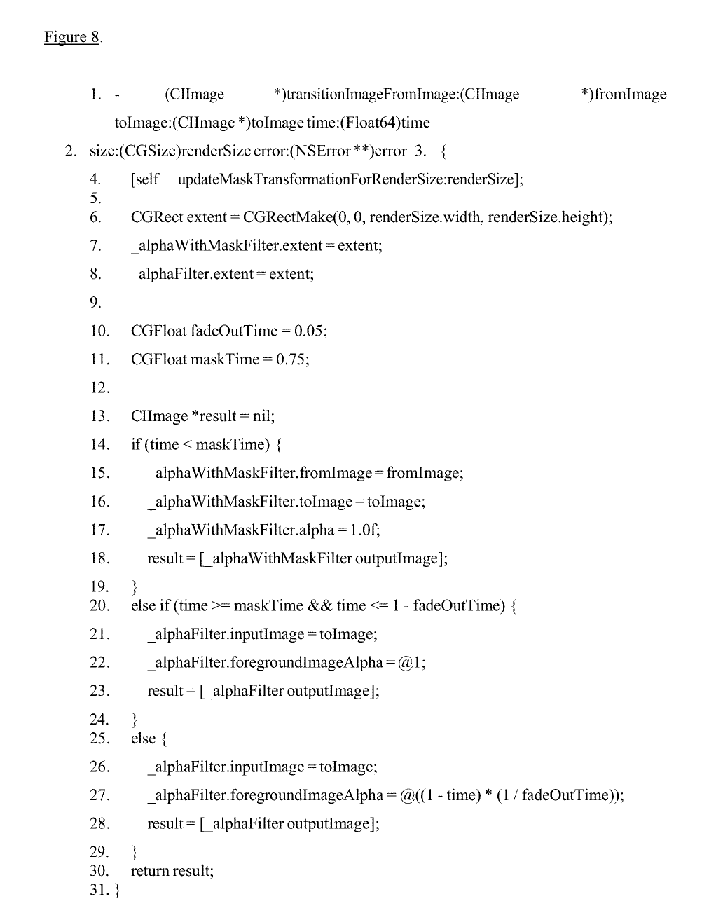

As shown in FIG. 3, the data servers 112 store and make accessible: the analytics data; the event data; the event media data; and settings data. The settings data represent settings for operation of the system 100: the settings data may be controlled and accessed by the administrator through the administration portal 106.

The media servers 114 store data representing the following: the EGC data, including EGC files, each with the pre-generated video and the pre-generated audio; the transition data; and the watermark data and the generated combined videos (generated by the user device 108). For example, these data can be stored in an MP4 format. The EGC data, the transition data and the watermark data may be uploaded to the media server 114 from the administration portal 106 via the data servers 112. For example, each of these data files may be uploaded by an administrator opening a web browser and navigating to an administrator portal, filling out a form, picking a video from an administrator computer, and clicking a submit button. This can also include, for example, from a mobile device and can be uploaded by a user not just an administrator.

The device 108 includes a device client 202. The device client 202 includes a communications module 204 that communicates with the server side 104 by sending and receiving communications data to and from the data servers 112, and receiving media data from the media servers 114. The device client 202 includes a generator module 206 that generates the combined videos. The device client 202 includes a user-interface (UI) module 208 that generates display data for display on the device 108 for the user, and receives user input data from the user-interface devices of the user device 108 to control the system 100.

The device 108 includes preferences data representing the preferences of the device client 202, which may be user-specific preferences of the device client 202, which may be user-specific preferences, for example: location, social log-ins, phone unique identifier, previous combined videos, other profile data or social data that is available.

The device 108 includes computer-readable storage 210 that stores the UGC data, and that sends the UGC data to the generator module 206 for generating the combined videos. The device 108 includes a camera module 212 that provides an application programming interface (API) allowing the user to capture images or videos and store them in the UGC data in the storage 210. The camera module 212 is configured to allow the device client 202 to capture images and/or videos using the camera of the device 108.

The device 108 includes a sharing module 214 that provides an API for the device client 202 to send the combined videos, or the references to the combined videos, to the safe networking systems.

All of the modules in the device 108, including modules 204, 206 and 208 provide APIs for interfacing with them.

Combined Video.

As readily apparent to one of skill in the art, FIG. 4 and other embodiments relating to Combined Video are in no way only limited to Combined Video with transitions only. As shown in FIG. 4, the combined video 300 includes a plurality of video and audio components, which may be referred to as “tracks”. The video components include a first pure component 302 and a last pure component 304. The first pure component 302 may be a pure-UGC component generated from the user-generated image or video, and the last pure component 304 may be a pure-EGC component generated from the pre-generated video, and the combined video 300 may be a “selfie-first” combined video. Alternatively, the first pure component 302 may be the pure-EGC component, and the second pure component 304 may be the pure-UGC component, and the combined video 300 may be a “selfie-last” combined video. Alternatively, the pure-UGC component may be preceded and followed by pure-EGC components, i.e., “bookended” by EGC. Alternatively, the pure-EGC component may be preceded and followed by pure-UGC components, i.e., “bookended” by UGC. In another embodiment, alternatively, EGC video or audio might be completely replaced with UGC video or audio such that the new video is all UGC video with EGC audio or conversely, all EGC video with UGC audio.

The combined video 300 includes an audio component 306 generated from the pre-generated audio of the EGC data. The first component 302 is synchronized or overlayed with the EGC audio component 306, and the second component 304 is also synchronized or overlayed with the EGC audio component 306, so that the EGC audio plays while both the UGC video and the EGC video are shown. The pure-EGC component and the audio component 306 are synchronized as in the pre-generated video represented by the EGC data in the remote server.

The combined video 300 may include an initial fade-in component 314, in which the video fades from black to display the first pure content 302. The combined video 300 may include a final fade-out component 316 during which the last pure component fades to black. The initial fade-in component 314 may be applied to the audio component 306 such that the volume fades in from zero. Similarly, the final fade-out component 316 may be applied to the audio component 306 so that the audio fades out to zero at the end of the combined video 300.

The combined video 300 includes a transition component 308. The transition component 308 includes a cross-fade component 310 in which the first pure component 302 (which may be the pure-UGC component 302 or the pure-EGC component 304) fades out and the last pure component (which may be the pure-EGC component 304 or the pure-UGC component 302 respectively) fades in. The transition component 308 includes a transition display component 312 in which the transition image or video is displayed in the middle, or at the beginning, or at the end, or elsewhere in the transition component 308.

During the transition component 308, the transition display component 312 may be a transparency behind which the first pure component 302 cross fades to the second pure component 304. The cross fade may be linear, as defined in the settings data, the preferences data, and/or the generator module 206. Alternatively, the cross fade may be a gradient-wipe transition based on gradients in the transition image. Alternatively, the cross fade may be a mask transition based on a mask in the transition image or video.

Due to the fade-in component 314 and the transition component 308, a first component 318, based on the EGC or UGC data, is at least partially displayed for a greater duration than the first pure component 302. Similarly, due to the fade-out component 316 and the transition component 308, a last component 320, based on the other of the EGC or UGC data, is at least partially displayed for a greater duration than the last pure component 302.

Each of the components is displayed for a pre-selected period of time (referred to as duration) that is defined in the settings data and accessed by the generator module 206. The initial fade-in component 314 may have duration of 0.2 seconds and the final fade-out component 316 may have duration of 0.2 seconds. The first pure component 302 may have duration of 5 seconds. The transition component 308 may have duration of 1.5 seconds. The transition display component 312 may have duration of 0.2 seconds or of 1.0 seconds. The second pure component 304 may have duration of 7.5 seconds. The total first component 318 may have a total duration of 6.5 seconds. The total last component 320 may have a total duration of 9 seconds. The durations of the first and second components 318, 320 (and thus the durations of the first and second pure components 302, 304), and the duration of the transition component 308, may be selected based on the types of the components 318, 320, 308. The types may be the UGC component and the EGC component: the UGC component may be selected to have a duration of 5 seconds, and the EGC component may have a selected duration of 9 seconds, regardless of which is first. If the UGC data represent a user-generated image only (and not a user-generated video), the duration of the UGC component may be selected to be less than the duration if the UGC data represent a user-generated video.

The UGC component may be generated from a user-generated image (which may be a photo) rather than a user-generated video. The UGC component may show the user-generated image as a static video, or a moving video that zooms and pans across the user-generated video (this may be referred to as a “Ken Burns effect”). The pan and zoom values for the transition may be defined in the setting data, the preferences data and/or the generator module 206. The zoom value may be from 1.0 to 1.4, where “1.0” means not zoomed in or zoomed out (i.e., 100%), “2.0” means zoomed in to the point of not being able to display half of pixels in the image, “0.0” means zoomed out to where double the amount of pixels in the image are displayed (e.g., the extra area would normally be rendered as black), and the values between 0.0 and 2.0 are related generally linearly to the fraction of displayed pixels.

For a user-generated video, the duration of the UGC component may be 5 seconds, whereas for a user-generated image, the duration of the UGC component may be 3 seconds. When the UGC data is determined to represent only the user-generated image, the total duration of content based on the UGC data may be less (3 seconds pure), and the total duration of the EGC component may be increased by the same amount (to 11 seconds pure) so the total duration of the combined video 300 is the same regardless of the type of the UGC data.

The watermark may be applied over the first component 302 and/or the second component 304. Alternatively, application of the watermark may be determined based on the type of component (UGC or EGC) regardless of which is first.

Method 400.

The system 100 performs a method 400 of video generation including the following steps, which may be implemented in part using one or more processors executing machine-readable commands:
the user device 108 accessing low-resolution images and/or descriptions (which may be referred to as “thumbnails”) of available EGC videos (which may be referred to as “clips”) for display on the user device 108 (step 402);
the user device 108 receiving user input to select one of the thumbnails, and to download (from the media servers 114) and play the clip in its totality (step 404);
the user device 108 receiving user input to mark events as favourites, and record these markings in the preferences data and/or the settings data (step 406);
the data servers 112 determining which events are popular when the user uploads the event to the system controlled through an admin rating system (-infinity to infinity) (step 408);
the user device 108 generating display data for the display of the user device 108 to display simultaneously two pre-combined images or pre-combined videos from the UGC data and the EGC data (in different places on the screen) prior to generating the combined video, and allowing selection and previewing of both through pre-combined images/videos through the user interface of the user device 108 (which may include the user swiping left to right to select different UGC files or EGC files) (step 410);
the user device 108 adding a user-generated video or photo while executing the method (which may be referred to as being “in the app”) by accessing the camera module or the stored photos in the user device 108 using pre-existing modules in the operating system of the user device 108 (step 412);
optionally, the user device 108 receiving a user input to select a transition instance, including a transition style and a transition duration, for the transition component 308;
the user device 108 receiving a single user input (which may be a button press on the user interface) to initiate the generating step once the EGC and UGC clips/images have been selected in the user interface (step 414);
the system 100 generating the combined video by the performing the generating method 500 described hereinafter (step 416); and
the user device 108 accepting user input to log into one of the hereinbefore-mentioned social media systems using one of the APIs on the user device 108, and to share the generated combined video using the APIs on the user device 108 (e.g., to Facebook, Twitter, Instagram, etc.), which may be by means of a reference to a location in the data servers 112 (e.g., a Website provided by the system 100), or by means of a media file containing the combined data (step 418).

The method 500 of generating the combined video may be performed at least in part by the generator module 206 which may perform (i.e., implement, execute or carry out), at least in examples, steps defined in objective C commands that are included hereinafter in the computer code Appendix A. In the computer code, the videos and images may be referred to as “assets”. The modules may be referred to as “methods” or “classes”. The combined video may be referred to as a “Kombie”.

As a general example and in no way intended to be limiting, generating the combined video following the method 500 thus may include the following steps:

defining hard-coded duration values for the combined video 300 (see code lines 19-28); alternatively, the duration values may be access in the settings data (step 502), or determined automatically (e.g., from an analysis of the EGC file duration), or selected by the user using the user interface;

allocating memory in the user device 108 for handling the assets (including the accessed and generated video and audio assets) used in the generating step (code lines 34 to 54) (step 504);

initializing operation of the generator module 206 from the parent module in the user interface of the device client 202 (code lines 56 to 73) (step 506);

setting the values of the variables used by the generator module 206 to 0 or nil, thus clearing the memory (code lines 74 to 97) (step 508);

initializing a function to control a progress bar for display by the user interface module 208 showing progress of the generating step for the user (code lines 98 to 102) (step 510);

accessing a dictionary in the preferences data which may be referred to as “NS Dictionary”, that is an array or list of file locations, including file paths (for local files on the user device 108), and remote locations for files in the media servers 114 (which may include universal resource locators, URLs), and filling the dictionary in the generator module 206 with the file locations in their preferences data (code lines 103 to 149) (step 512);

fetching the assets from the remote storage or the local storage each in separate operational threads (code lines 147 to 148), including fetching the three audio visual (AV) assets using the three locations (which may be URLs) is commenced by one method for each set that run in parallel and on background threads of the operating system (see code lines 152 to 287) (step 514);

accessing and retrieving the user asset, which includes the user-generated image or video, and associated dimensions data and meta data associated with the user-generated image or video (code lines 168 to 208), including counting the number of video sets retrieved by the plurality of parallel threads (code lines 176, 219 and 247) and calling the combined video creation process once all the assets have been retrieved (code lines 179 to 185, 222 to 228, or 257 to 263) (step 516);

if the UGC data represent a user-generated video, saving it to local memory in the user device 108 (code lines 196 to 200) (step 518);

if the UGC data represent a user-generated image, calling a method to generate an AV asset from a local image object (code lines 201 to 204) (step 520);

accessing and retrieving the pre-generated video from the remote server (code lines 211 to 236) (step 522);

accessing and retrieving the transition image or video from the media servers 114, or from the storage of the user device 108 (code lines 239 to 271) (step 524);

in some embodiments (not in the Appendix A), if the transition data represent a transition image, calling a method to convert the transition image to an intermediate transition video, as described hereinafter (conversion method is in code lines 416 and 455) (step 526);

in some embodiments, if the transition data represent a transition video, accessing and downloading the transition video from the determined location (code line 237) (step 528);

after retrieving all AV assets in the background, calling the combination engine (code lines 302 to 342), including passing the created combined video back to the parent module (which may be referred to as a “class”), including passing an asset dictionary that includes the three AV assets (all videos, which may have been converted from images in the asset retrieval step) to the combination engine (step 530);

in some embodiments, retrieving one or more videos from the remote server, and writing them to a local file in memory, which may be called by the asset-retrieval method, and thus included in the asset-retrieval step (code lines 1263 to 1312), which includes accessing and retrieving the remote data based on allocation identifier for a location of the remote data, retrieving an AV asset from a local location, retrieving an AV asset from a remote image location (and converting to a video if necessary), and retrieving an AV asset from a local image location (see code lines 968 to 1112) (step 532);

creating the combined video using the asset dictionary (code lines 344 to 966), including accessing the asset dictionary with the three assets, assigning the first video asset to local memory (code line 360), assigning the second video asset to local memory, where the first and second video assets can be pre-generated video and the user-generated video or an intermediate user-generated video that has been automatically generated based on the user-generated image (code line 361), and assigning the transition video, which may be the original transition video or an intermediate transition video automatically generated based on the transition image, to local memory (code line 362), and in embodiments assigning a fourth AV asset, including only the audio from the pre-generated video in the EGC data, to local memory (code line 363)—in alternative embodiments, the audio asset may be accessed from a separate location defined by the dictionary rather than being extracted from the pre-generated video (code lines 366 and 369, which are commented out) (step 534);

creating a digital composition object to hold the assets during the combination process (line 386) (step 536);

generating a first video component by adding only video of the first video asset (lines 394 to 399) (step 538);

setting the first track time range to start at the finish of the first video asset (code lines 402 to 403) (step 540);

creating the second video component from the second video asset to include only video and no audio (code lines 407 to 412) (step 542):

setting the second time track range as start to finish of the second video asset: i.e., using the entire track range of the second video asset (EGC) as a marker for how long the created combined video will be, allowing the method to operate if a file conversation mishap occurs, e.g., if the duration of the EGC gets shortened from 14 seconds to 13 seconds when encoded/decoding/transferring between servers (code lines 415 to 417) (step 544);

creating an audio track from the first video asset (code lines 421 to 431) (step 546);

creating a main composition instruction to hold instructions containing the video tracks, in which the layer instructions denote how and when to present to video tracks (code lines 437 to 493) (step 548);

in embodiments, if an image was used to create the UGC data, applying the Ken Burns effect, or a different effect based on a selected theme setting, to transform the appropriate video asset (code lines 458 to 469) (step 550);

creating a main video composition to hold the main instruction including setting the video dimensions (code lines 499 to 507) (step 552);

creating core animation layers for the transition image asset to be applied, including creating animation instructions to fade the transition image asset in and out, and applying the core animation layers to the main video composition (code lines 515 to 573) (step 554);

in embodiments, combining the pre-generated video with the user-generated image or video without the transition image or video, by appending two video sets and one audio asset to an AV track (step 556) This could also include, for example, various Kombie related applications described further herein, such as not including transitions;

preparing and exporting the main video composition, including using a temporary file path (code lines 577 to 659) (step 558);

in embodiments, setting fade-in durations and fade-out durations for the three tracks, including the fade-in and fade-out durations pre-set in the settings data, which may be performed by adjusting the opacity of the video tracks from 0 to 1, (for fading in) and from 1 to 0 (for fading out) (step 560);

setting the size for all of the video sets and components in the combined video to be the same (code lines 504 to 506) (step 562);

setting a common frame rate for all of the video components (code line 507) (step 564);

in some embodiments, adding a watermark to one of the components (step 566);

in some embodiments, pulling the audio out of the original EGC data, and inserting it as a track for the entire duration (step 568); and

saving and exporting the created combined video to file, including to a combined album in the computer-readable memory of the user device 108 (step 570).

This could include, for example, pre-defined recorded lengths with video and audio recording being activated automatically, such as for educational purposes for example. This might also be accompanied with audio and/or video signifiers (eg sparkle overlay, chimes) that signify auto recording is about to commence.

In some instances, the step of creating the intermediate transition video from the transition image, or the intermediate user-generated video from the user-generated image may include converting the static images into a video file using routines from the AV Foundation framework from Apple Inc. This includes ensuring the image corresponds to a pre-defined size in the settings data, e.g., 320 by 320 pixels (code lines 1143 to 1144). A buffer is created and filled with pixels to create the video by repeatedly adding the image to the buffer (lines 1166 to 1208) including grabbing each image and appending it to the video until the maximum duration of the intermediate video is reached, and each image is displayed for a pre-selected duration, e.g., one second (code lines 1185 to 1186). The intermediate video creation process finishes by returning a location (e.g., a URL) of the created file which is stored in temporary memory of the user device 108.

The dictionary, referred to as “NS dictionary” in the code, includes image data and metadata used by a video writer, e.g., from the AV Foundation framework. The video settings may be passed to video creation sub-routines using the dictionary.

In some instances, instead of generating and appending the video assets (i.e., the first video asset, the second video asset, the transition asset, and audio track) in steps 536 to 558 of method 500, the generator module 206 assembles the combined video frame-by-frame. Each frame is selected from one of the data sources comprising the UGC data, the EGC data, or the transition data. The generator module 206 determines which data source to use for each frame based on a theme setting in preferences data. The theme setting includes data accessed by the generator module 206 for each frame as the combined video is assembled. Each frame can include a UGC frame from the UGC data, an EGC frame from the EGC data, a transition frame from the transition data, or a blend frame that includes a blend of the UGC, EGC and/or transition data. One of a plurality of blending methods, which is used to generate the blend frame, can be selected based on the theme setting. An example theme is a “cross-fade with mask” theme, in which an initial frame is purely from one UGC/EGC data source, a final frame is purely from the other UGC/EGC data source, and the intermediate frames incorporate increasing pixels from the other source in a cross-fade transition, and during the transition, a selected mask of pixels is applied to a series of the frames. Example computer code implementing the “cross-fade with mask” theme is included in Appendix B.

The combined audio track is by default the EGC audio track. In embodiments, the UGC audio is mixed into the combined audio track. Adding the audio track is implemented separately from the frame-by-frame assembly process. Once the frame-by-frame assembly is completed, the generator module 206 adds the EGC audio track to the video, e.g., using processes defined in the AV Foundation framework.

In some instances, the generated combined video can be generated in less than 2 seconds on older commercially available devices, and in even less time on newer devices. The user interface may include a screen transition during this generation process, and there may therefore be no substantial noticeable delay by the user of the generation of the combined video before it can be viewed using the device 108.

In some instances, the combined video is transcoded from its raw combined format into a different sharing format for sharing to the devices 110 or the servers associated with social network systems. The transcoding process is an intensive task for central processing unit (CPU) and input-output components of the device 108. For example, using the AV Foundation and Core Image processing modules, the transcoding may take 12 seconds on an Apple iPhone 4s, or 2.5 seconds on an iPhone 6. The transcoding process is initiated when viewing of the combined video is commenced, thus, for a typical combined video length of 14 seconds, the transcoded file or files are ready for sharing before viewing of the combined video is finished.

Alternatives.

In some instances, the system 100 can use locally generated EGC, i.e., “local” EGC generated on the client side 102, including local EGC captured (using the camera) and stored in the device 108. In these instances, the EGC is user-generated in the same way as the UGC, and thus the EGC is not “external” to the device 108, although the combined video generation process still uses the local EGC in the same way as it uses the external EGC. In these instances, the device 108 is configured to access the local EGC content (the photo or the video) on the portable electronic device itself (i.e., the EGC data is stored in the device 108), rather than accessing the EGC from the server side 104. This can be selected by the user using the user interface, e.g., using a menu system or folder system or thumbnail system to select EGC on the server or pre-generated videos/photos (also referred to as local “EGC” in this context) on the portable electronic device 108 itself In these instances, the user device 108 can display available pre-recorded images and videos in the device 108 in step 402. Once selected in the processing method 400, the locally sourced EGC is subsequently treated in the same way as the externally sourced EGC.

In some instances, an instance of the transition component 308 is selected by the user through the user interface after the EGC and the UGC have been selected. Thus the method 400 includes a step of the device 108 receiving user instructions, via the user interface, to select a style and duration of the transition instance. Available pre-defined transition styles, and available transition durations, are made available through the user interface, and the user can select a style and duration for the instance of the transition component 308 to be inserted in between the EGC and the UGC.

In some instances, the duration for an instance of the combined video 300 can be determined from the pre-existing of the EGC video that is selected for that instance, rather than being pre-set for all instances. The combined-video duration can be equal to the EGC duration, or can be equal to the EGC duration plus a pre-selected or user-selected time for the other components, including the fade-in component 314 (can be pre-selected), the fade-out component 316 (can be pre-selected), the transition component 308 (can be user-selected), and/or the UGC component 318 (can be user-selected). The duration of the EGC can be determined from a duration value represented in metadata associated with the EGC file, or using a duration-identification step on the server side 104 (e.g., in the media content servers 114) or on the client side 102 (e.g., in the user device 108), e.g., using a duration-identification tool in the AV Foundation framework.

In some instances, the combined video 300 can include a plurality of transitions, and a plurality of instances of UGC components and/or EGC components. For example, the selected EGC can define the duration of the combined video instance, the user can select a plurality of UGC components (e.g., by recording a plurality of selfie videos), the user can select a transition instance at the start and/or end of each UGC component, and the combined video can be generated from these components. Or, for example, in accordance with various embodiments herein, the combined video could not include any transitions.

In some instances, the audio component 306 of the combined video 300 is generated from the audio of the UGC data. The first component 302 is synchronized or overlaid with the UGC audio component, and the second component 304 is also synchronized or overlaid with the UGC audio component, so that the UGC audio plays while both the UGC video and the EGC videos are shown. The pure-UGC component and the audio component 306 are synchronized as in the original UGC video.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Various embodiments of the invention can specifically include or exclude any of these variations or elements.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### Kombie Application

In one embodiment, as disclosed herein, the application disclosed herein is referred to as the Kombie application. The Base Content Piece (BCP), which is data that represent a pre-generated video of any length including pre-generated audio, was uploaded to the Kombie Application from a server or directly from the device's own memory (camera roll) to act as the basis of new video creation. Additional Content Piece(s) (ACP)—which can be User Generated Content including audio or video, a combination of both or a still photo—were added to the BCP. ACP would be added at any point in the time line of BCP. The addition of ACP to BCP replaces, in whole or part thereof, the audio, video or both of the BCP to create an entirely new content piece. This process may be repeated until the user has finished adding ACP thus creating a Final Content Piece (FCP). In some embodiments, the FCP is referred to as a Kombie.

ACP can be recorded in the application from the device's camera or accessed from the devices own memory or streamed live, or accessed from a server.

BCP, if delivered from the device's own memory (camera roll), was held in the devices cache to be recorded over or added to ACPs.

The In/Out recording of ACP over BCP could be performed at any point in the timeline of the BCP. This included recording or adding further ACP to replace an already added ACP. In one example, having recorded a segment of ACP onto the BCP, the BCP being a Beyonce Video Clip, the inventor was able to see Beyonce, and then himself, and he could then go back and record inside his first ACP and replace that. To the extent that the inventor's first ACP was Audio and Video, it left no trace of the BCP (Beyonce). He was them able to use the new ACP as a BCP. Thus, when another user re-Kombie'ed the inventor's Beyonce Kombie, the new user might no longer see Beyonce in the clip.

In one embodiment, the application further has a unique Multi-Function Button (MFB). The MFB offered Play, Stop, Record, Camera Viewfinder, Tap to Stop, and Play BPC content functionality. Tap and Hold to Record ACP at any time which records the camera content (live content) viewable in the MFB into the BCP. When the MFB is tapped and held the content viewable in the MFB is now displayed in full in the Device screen. In one embodiment, the inventor found that BCP could essentially swap into the MFB screen. In one embodiment, the user can double tap the multi-function button to start recording.

In one embodiment, the Kombie application provided a unique timeline display of the BCP and ACP at top of the Application screen.

In another embodiment, the Kombie application provided a Unique Camera image display in the MFB.

In another embodiment, the Kombie application provided real time In/Out recording of ACP over BCP along any point of the BCP timeline.

In another embodiment, the Kombie application provided user flow-BCP displayed in full on the Device Screen proper with the UGC content displayed in the MFB. Tapping the MFB played the BCP. When the user is ready they tap and hold the MFB button to record ACP (Camera content) into the timeline. When the MFB was released the BCP continued playing providing a dynamic in/out recording UI and UX that is unique, such as Real Time Live In/Out Playback and record.

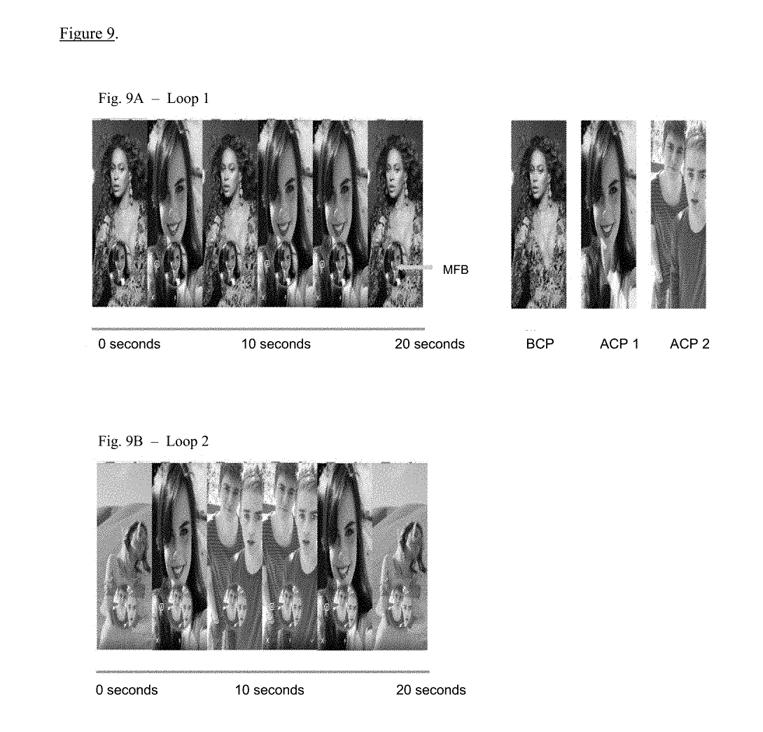

In accordance with various embodiments herein, an example of Kombie Application is further described in FIG. 9 herein.

### Example 2

### Educational Use

In one embodiment, the present invention provides an application that may be used in conjunction with educational programs or content to provide interactive educational experience. For example, in accordance with various embodiments herein, the Kombie application may be used effectively in educational programs, where the user may record their video over the pre-existing base content video. In case of educational programs, for example, a child watching an educational program in an electronic device may record his own video and incorporate that into the pre-existing commercially available educational video. This allows the child to have a more interactive learning experience. This interactive educational tool provides benefits such as developing identity through role-playing, self-motivated repetitive learning, seeing themselves helps them to understand how to speak, hand-eye coordination. Kombie's kineasthetic learning improves on kids watching video and zoning out. Moreover parents and teachers are able to access additional educational data feedback.

### Example 3

### Kombie Kids/Educational Use

In accordance with various embodiments herein, Kombie Kids—BCP (Base Content Piece) of video is uploaded to Kombie from the server and a multiple of user behaviours/outcomes are possible:

USER EXAMPLE 1) the BCP plays, either automatically or is activated by the play button of the Kombie Kids Application, then at pre-defined points in the time-line of the BCP, the in-built device camera and the in-built device microphone are activated, recording the user's image and audio (user generated content) that is an Additional Content Piece (ACP) that will be added to the BCP, creating a new combined video that includes both ACP and BCP audio and video. This new video then automatically loops around and the user views the combined video. This new video can be saved and also be shared. Alternatively, by hitting the Undo Button the user can repeat the actions described. In the above example the microphone does not always need to be engaged. In the above example, pre-designated snapchat style augmented reality lenses/masks might be automatically added to the child's face when in record mode; in the above example, sound activated predesignated voice effects (which could be a mix of audio effects include pitch, EQ, reverb and delays and/or audio samples so that the users voice activates or is made to simulate the sounds of other things or beings e.g car horn, cows moo, or high-pitched squeaky voice sound) might be automatically generated at predesignated auto record points. In the above example the user can engage the manual Multi Function Record Button (MFB) by tapping on a button and can now over-ride the auto record button, so that the user can record at additional points in the timeline or make the auto record sections longer. The predesignated Auto record sections continue to engage auto recording as they did previously.

USER EXAMPLE 2) Application Functionality that does not include predesignated AutoRecord sequences. In this instance the BCP plays or is made to play by engaging the Play button, and then by tapping and holding the multi-function record button (MFB) the user activates the in-built device camera and the in-built device microphone, recording the user's image and audio (user generated content) that is an Additional Content Piece (ACP) that will be added to the BCP, creating a new combined video that includes both ACP and BCP audio and video. This new video then automatically loops around and the user views the combined video. The user can repeat the above steps adding more and more ACP including ACP inside their own previously created ACP. This new video can be saved and also be shared. In the above example, pre-designated or user-chosen snapchat style augmented reality lenses/masks might be automatically added to the child's face when in record mode; in the above example, sound activated predesignated or user-chosen voice effects (which could be a mix of audio effects include pitch, EQ, reverb and delays and/or audio samples so that the users voice activates or is made to simulate the sounds of other things or beings e.g car horn, cows moo, or high-pitched squeaky voice sound) can be activated when the MFB is activated.

USER EXAMPLE 3) for both AutoRecord (User example 1) and Manual Record (User example 2) before beginning to play the BCP, the user is able to choose Augmented Reality Masks and/or Voice Effects via menu items or buttons. Having engaged either one of those menu choices the users image becomes the main image in the main screen of the device and the chosen mask and voice effects are applied and are visible and audible. These steps can be repeated. Once the video play button is engaged the BCP video is what is viewed in the main screen as per usual operation of Kombie Kids or Kombie. (ALL of the user behaviours described here are applicable to the kombie technology.).

USER EXAMPLE 4: Whereby the ACP displaces the BCP, such that when the MFB is activated (in either Manual or Auto-record override mode) and new ACP is created it does not record over the BCP, instead it moves the BCP point at which the ACP started to the end of that ACP. In this instance, if an ACP of 4 seconds was added to a 15 second BCP, the resulting new combined video would be 19 seconds long containing 15 seconds of BCP and 4 seconds of ACP. The ACP can be added at any point in the timeline and can both be added before the start of the BCP and can also be added to the end of the BCP. These steps can be repeated multiple times. The above mentioned masks and voices can exist in these standalone ACPs.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

1. A method of generating video data, comprising:
providing a Base Content Piece (BCP) and an Additional Content Piece (ACP); and
incorporating the ACP into the BCP to generate the video data,
wherein the video data is implemented by a device with at least one processor.

2. The method of claim 1, wherein the video data is generated on a portable electronic device.

3. The method of claim 1, wherein the video data is generated on a server.

4. The method of claims 1-3, wherein the BCP comprises a pre-generated video and/or audio.

5. The method of claim 1-3, wherein the BCP is a professional video.

6. The method of claim 1-3, wherein the BCP is uploaded from another device.

7. The method of claim 1-3, wherein the BCP is User Generated Content (UGC), and/or from the camera roll of that device.

8. The method of claims 1-3, wherein the ACP is UGC.

9. The method of claims 1-3, wherein the ACP comprises audio, video, still image, GIF, photo, or series of photos, or combinations thereof

10. The method of claims 1-3, wherein the ACP is uploaded from another device, including pre-generated and professionally generated content.

11. The method of claims 1-3, wherein the ACP is from the camera roll of that device.

12. The method of claim 1-3, wherein the ACP is video from a camera of the device.

13. The method of claims 1-12, wherein the ACP can be added at any point in the time line of the BCP.

14. The method of claims 1-12, wherein incorporating the ACP in the BCP replaces the audio or video or parts thereof to create the video data.

15. The method of claims 1-12, wherein the incorporating step may be repeated several times by adding several iterations of BCP and ACP.

16. The method of claims 1-15, wherein the video data creates a new type of brand activation that offers engagement and visibility across all social and messaging applications.

17. The method of claim 16, wherein the brand activation is created for every user's share on any social or direct messaging platform.

18. The method of claim 1-16, wherein the video data is used for one or more of the following purposes: education, instruction, recruitment, polling, human resources, evaluation, assessment, diagnosis, posting on a social network, posting on video hosting sites, chat messaging, and commentary on the BCP.

19. A method of generating video data on a portable electronic device, or server, comprising the steps of:
the portable electronic device accessing pre-generated data representing a pregenerated video synchronized with pre-generated audio;
the portable electronic device accessing user-generated content (UGC) data representing a user-generated photo or video generated by a camera of the portable electronic device; and
the portable electronic device generating combined data representing a combined video that includes a portion of each of the pre-generated video, and the user-generated photo or video.

20. The method of claim 19, further comprising the portable electronic device accessing transition data representing a transition image or transition video, and/or generating the combined video data by including the transition image or transition video in the combined video data.

21. The method of claim 19, wherein the generating step comprises generating a transition component from the BCP to the ACP, or from the ACP to the BCP, based on a transition shape in the transition image wherein one or more of the following apply:
wherein the transition image defines one or more two-dimensional (2D) shapes;
wherein the transition shape includes a plurality of regions;
wherein the transition image includes pixel values defining masks in the transition image;
wherein the generating step includes a step of generating a masking transition between the user-generated video or image and the video based on the image mask; and/or
wherein the portable electronic device accesses the transition data on the remote server system using a telecommunications network.

22. The method of claim 19, further comprising the step of generating intermediate transition data representing an intermediate transition video including a plurality of video frames based on the transition image, wherein the generating step includes a step of combining the intermediate transition video with at least the portion of each of the pre-generated video and the user-generated image or video.

23. The method of claim 19, wherein the combined data represent a plurality of frames of the pre-generated video, a plurality of frames of the transition image or video, and a plurality of frames of the user-generated image or video.

24. The method of claim 23, wherein the combined data comprises synchronization with pre-generated audio.

25. The method of any one of claims 19-25, further comprising the device generating combined data by synchronizing at least a portion of pre-generated audio with each of the pre-generated video and user-generated photo or video.

26. The method of any one of claims 19-25, further comprising the portable electronic device generating combined data by synchronizing at least a portion of user-generated audio from the UGC with each of the pre-generated video and the user-generated photo or video.

27. The method of claim 21, wherein the transition is selected by machine readable instructions contained in the BCP.

28. The method of claim 19, further comprising a step of fading in the pre-generated audio over a fade-in duration at a start of the combined video to generate the combined data and/or including a step of fading out the pre-generated audio over a fade-out duration at an end of the combined video to generate the combined data.

29. The method of claim 19, further comprising a step of the portable electronic device cross-fading the pre-generated audio to the user-generated audio and/or crossfading the user-generated audio to the pre-generated audio, over at least one crossfade duration in at least one corresponding intermediate portion of the combined video to generate the combined data.

30. The method of claim 1 or 19, further comprising a step of accessing, on the portable electronic device or from the remote server system, watermark data representing a watermark image or video, and the generating step including the portable electronic device inserting the watermark image or video into the video data.

31. The method of claim 30, wherein the watermark is inserted into at least a portion of the BCP, and/or at least a portion of the ACP.

32. The method of claim 31, wherein the watermark is inserted onto any part of the video data.

33. A method of generating video data, comprising:
a portable electronic device accessing pre-generated data representing a pre-generated video synchronized with pre-generated audio;
the portable electronic device accessing user-generated content (UGC) data representing a user-generated photo or video generated by a camera of the portable electronic device;
the portable electronic device accessing transition data representing a transition image; and
the portable electronic device generating combined data representing a combined video that includes a portion of each of the pre-generated video, the user-generated photo or video, and the transition image, synchronized with at least a portion of the pre-generated audio.

34. The method of any one of claims 1-33, further comprising the step of incorporating overlays or video effects into either the BCP or ACP.

35. The method of claim 34, where the video effect or overlay is incorporated based on elements in the video data.

36. The method of claim 35, where the video effect or overlay is incorporated based on the position of a face, person, or other object in the video data.

37. The method of claim 36 where the face, person or other object in the video is being tracked regardless of whether the video is being used as part of the combined video data.

38. Machine-readable media including machine-readable instructions that control one or more electronic microprocessors to perform the method of any one of claims 1-37.

39. The method of claim 38, wherein the machine-readable instructions are incorporated into the BCP.

40. The method of claim 1, further comprising a Multi-Function Button (MFB).

41. The method of claim 40, wherein the MFB offers functionality including Play, Stop, Record, Camera Viewfinder, Tap to Stop, or Play BCP, or combinations thereof.

42. The method of claim 40, further comprising a timeline display of the BCP and ACP in the application screen.

43. The method of claim 40, further comprising a camera image display in the MFB.

44. The method of claim 43, wherein a video is playing on the screen whilst a camera is open in the record button.

45. The method of claim 40, wherein the MFB is used to create machine readable instructions for the further insertion of other ACP into the combined video data.

46. The method of claim 40, wherein the MFB offers functionality of Tap and Hold to Record with Camera Viewfinder.

47. The method of claim 40, wherein the ACP comprises live captured video and/or audio.

48. An apparatus configured to perform the method of any one of claims 1-47.

49. A system configured to perform the method of any one of claims 1-47.

50. A portable device configured to perform the method of any one of claims 1-47.

51. An apparatus, comprising:
a device capable of generating video data by incorporating an Additional Content Piece (ACP) into a Base Content Piece (BCP); and
a Camera Viewfinder that allows the user to track their face and pre load masks as a video effect and/or overlay of the video data.

52. The apparatus of claim 51, further comprising a means of having pre-defined sections that also include lenses and voices.

53. The apparatus of claim 52, wherein the means of having pre-defined sections is described in FIG. 10 herein.

54. The apparatus of claim 51, further comprising a means of replacing audio and video allowing user to comment on the video.

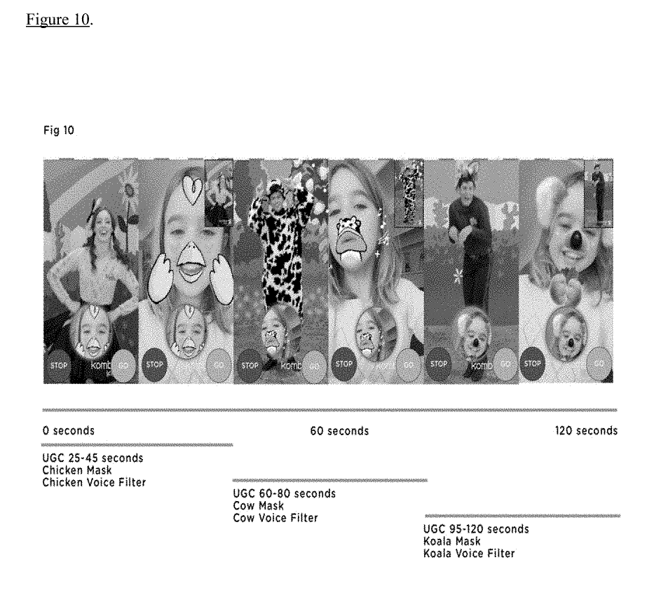

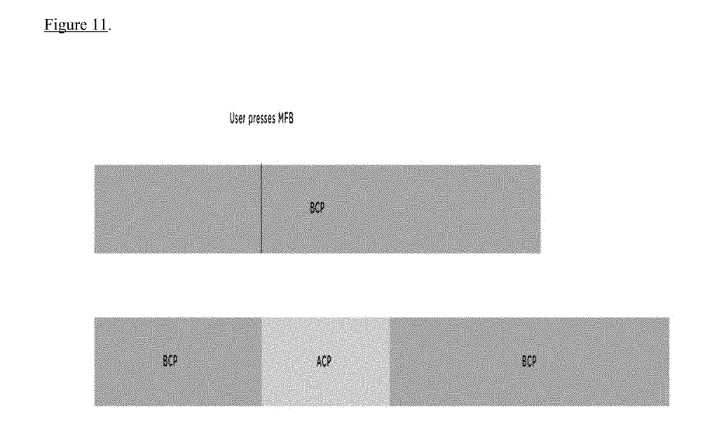

55. The apparatus of claim 54, wherein the means of replacing audio and video is described in FIG. 11 herein.
